(19) United States
(12) Patent Application Publication
(10) Pub. No.: US 2026/0189019 A1
(43) Pub. Date: Jul. 2, 2026

(54) VOLTAGE-FREQUENCY CONTROL FOR HOME ENERGY SYSTEMS

(71) Applicant: FORD GLOBAL TECHNOLOGIES, LLC, Dearborn, MI (US)

(72) Inventors: Haider Mhiesan, Canton, MI (US); Yuan Zhang, Canton, MI (US); Timothy Harris, Grosse Ile, MI (US); Mark J. Ferrel, Sunset Beach, NC (US)

(21) Appl. No.: 19/417,474

(22) Filed: Dec. 12, 2025

Related U.S. Application Data
(60) Provisional application No. 63/739,980, filed on Dec. 30, 2024.

(51) Int. Cl. H02J 3/388; B60L 3/00; B60L 55/00; H02J 3/00; H02J 3/0014; H02J 3/16; H02J 3/175; H02J 3/32; H02J 9/04; H02J 13/12; H02J 101/24

(52) U.S. Cl. CPC H02J 3/388; B60L 3/003; B60L 55/00; H02J 3/00142; H02J 3/003; H02J 3/16; H02J 3/175; H02J 3/322; H02J 9/04; H02J 13/12; B60L 2210/10; B60L 2210/42; H02J 2101/24

(57) ABSTRACT

An energy management system delivers power to a load during an islanded condition by operating a power converter that produces an AC output on a power line with a reference amplitude and a reference frequency. A controller directs the power converter to control the output by adjusting amplitude while maintaining the reference frequency, adjusting frequency while maintaining the reference amplitude, or adjusting amplitude and frequency together when conditions on the power line indicate a need for coordinated control. The system supports stable operation of an isolated AC bus by selecting between single-parameter and dual-parameter adjustment based on real-time electrical conditions and by modifying the output to supply appropriate real and reactive power to the load.

### CROSS-REFERENCE TO RELATED APPLICATION

This application claims the benefit of U.S. provisional application Ser. No. 63/739,980, filed Dec. 30, 2024, the disclosure of which is hereby incorporated in its entirety by reference herein.

### TECHNICAL FIELD

This disclosure relates to power management.

### BACKGROUND

A residential energy system can distribute alternating current from multiple sources, including a utility grid connection, photovoltaic equipment, and an electric vehicle.

### SUMMARY

An energy management system delivers power to a load during an islanded condition by operating a power converter that generates a reference waveform on a power line. A controller directs the power converter to adjust the waveform by varying amplitude while holding frequency constant, varying frequency while holding amplitude constant, or varying both amplitude and frequency at the same time. The power converter may reside within a home-energy-management enclosure that includes an auxiliary low-voltage supply for maintaining controller operation, may receive information from electric-vehicle supply equipment indicating whether an electric vehicle is connected, may draw traction-battery power when located in the vehicle, and may coordinate amplitude or frequency adjustments with a grid-following device based on its electrical contribution to the power line.

A vehicle includes a traction battery, an inverter, and a controller that operates the inverter to establish a reference voltage on an external power line during a grid-loss condition. The controller permits either amplitude adjustment while holding frequency within a defined stability range or frequency adjustment while holding amplitude within its stability range, and initiates concurrent amplitude-and-frequency adjustment when deviation from the corresponding stability range indicates that single-parameter adjustment is insufficient. The controller may also limit the degree of amplitude or frequency adjustment when the traction-battery state of charge drops below a threshold.

A method of operating a power converter during an islanded condition includes generating an AC waveform on an AC bus having a reference amplitude and reference frequency. The method further includes adjusting only amplitude or only frequency in response to bus conditions, and subsequently adjusting both amplitude and frequency when a load-related condition indicates that single-parameter adjustment is inadequate. The method may rely on voltage deviation, dV/dt, frequency deviation, RoCoF, real-power changes, or reactive-power demand to select the control axis, and may implement reactive-power modulation, real-power modulation, droop-slope adjustment, or time-based correction intervals. Combined amplitude-and-frequency adjustment may occur when control limits or persistent deviations are detected and may involve coordinated active-and reactive-power delivery, adaptive thresholds based on historical load signatures, or predictive adjustments anticipating voltage-or frequency-related disturbances.

A home energy system includes an AC bus, a power converter that generates an AC waveform establishing bus voltage and frequency during islanded operation, and a controller that directs converter behavior through mode selection based on load-related conditions on the AC bus. The controller operates the converter in a first control mode that adjusts either a voltage-control parameter or a frequency-control parameter while maintaining the other within a stored stability range. When conditions indicate that this single-axis approach cannot maintain both electrical quantities within their stability ranges, the controller directs the converter into a combined control mode in which both parameters are adjusted. In some arrangements the converter is housed within a home-energy-management enclosure with an auxiliary power source, or the controller selects the first control mode based on signals from electric-vehicle supply equipment or a photovoltaic inverter.

A controller directs operation of a power converter on an AC bus by generating command signals based on load-related conditions. The controller selects a first control mode that applies either voltage-focused adjustment while holding frequency within a frequency stability range, or frequency-focused adjustment while holding voltage within a voltage stability range. When measured conditions show that the first control mode does not stabilize voltage or frequency, the controller issues command signals that place the converter into a combined control mode that adjusts both parameters. Mode selection may depend on deviations evaluated over a defined interval, and stored data representing prior load-related conditions may be used to revise a transition threshold.

A method for operating a power converter on an islanded AC bus includes generating an AC waveform that establishes bus voltage and frequency, operating the converter in a first control mode based on a load-related condition, and maintaining one electrical quantity within its stability range while adjusting the other. When the bus voltage or bus frequency falls outside a stored stability range during this mode, the converter is operated in a combined control mode that adjusts both parameters. The first control mode may be entered based on thresholds related to voltage deviation, frequency deviation, rate of change, real-power demand, or reactive-power demand. Additional steps may include droop-slope adjustments, soft-transient changes, sequential operation of multiple modes, recording load signatures, updating transition thresholds, and predicting disturbances based on historical load data.

A home energy system includes an AC bus, a power converter coupled to the AC bus that generates an AC waveform establishing bus voltage and bus frequency when no external voltage source is present, and a controller that operates the power converter in a voltage-focused, frequency-focused, or combined mode based on load conditions on the AC bus. The controller adjusts voltage-control and frequency-control parameters in accordance with the selected mode, may vary bus waveform characteristics and bus frequency, and may draw support power from an auxiliary source within a home energy management structure. The system may interact with a photovoltaic inverter, electric vehicle supply equipment, an electric vehicle, or a grid-following device, and may base the selected control mode on power available from such components.

A controller directs operation of a power converter coupled to an AC bus by receiving information about load conditions on the bus, selecting a voltage-focused, frequency-focused, or combined control mode based on those conditions, and issuing command signals that adjust voltage-control and frequency-control parameters of the power converter in accordance with the selected mode. The controller also modifies future mode selections using information stored from past load behavior. Stored information may include values associated with magnitude, rate of change, or time-varying patterns of bus loading, and may influence selection through parameter adjustment, weighted mode emphasis, trend-based operation, or transitions toward the combined mode when load behavior changes over time.

A method of operating a power converter coupled to an AC bus includes generating an AC waveform that establishes bus voltage and bus frequency when no external voltage source is present, operating the converter in a first mode selected from a voltage-focused mode, a frequency-focused mode, and a combined mode based on a first load condition, and then operating the converter in a different mode based on a second load condition. The method may include recording load behavior over time, selecting modes based on recurring load patterns, applying transition sequences during mode changes, modifying the relative influence of voltage-related and frequency-related control, and basing mode decisions on load magnitude, load rate-of-change, photovoltaic power availability, or interactions with electric-vehicle charging and discharging.

### BRIEF DESCRIPTION OF THE DRAWINGS

FIG. 1 is a schematic diagram of a home energy system that includes a power converter located within a system housing, an auxiliary power controller and auxiliary battery positioned in the housing, and a converter battery located in a separate external enclosure.

FIG. 2 is a schematic diagram of an alternative configuration in which the power converter is electrically connected upstream of a relay associated with a neutral-forming transformer.

FIG. 3A is a schematic diagram of an embodiment in which the power converter, converter battery, auxiliary power controller, and auxiliary battery are all contained within the main system housing.

FIG. 3B is a schematic diagram of an embodiment in which the power converter, converter battery, and auxiliary power controller are co-located within a shared external enclosure separate from the main system housing.

FIG. 3C is a schematic diagram of an embodiment in which the power converter, converter battery, and auxiliary power controller are positioned within the system housing.

FIG. 4 is a schematic diagram of an electric vehicle including a power converter connected to the traction battery through onboard control electronics.

FIG. 5A is a schematic diagram of an electric vehicle architecture in which both the AC charger and the power converter receive power from the traction battery through respective DC/DC converters.

FIG. 5B is a schematic diagram of an electric vehicle architecture in which the power converter receives power through a downstream point on the AC charger.

FIG. 5C is a schematic diagram of an electric vehicle architecture in which the power converter receives its input from an auxiliary low-voltage battery.

FIG. 5D is a schematic diagram of an electric vehicle architecture in which a DC/DC converter of the AC charger supplies conditioned DC power to both the charger inverter and the power converter.

FIG. 6 is a schematic diagram of electric vehicle supply equipment including a power converter, a vehicle interface, a relay contactor, and associated control electronics.

FIG. 7A is a schematic diagram of an embodiment in which the power inverter and its battery are housed together in a dedicated external enclosure separate from the EVSE housing.

FIG. 7B is a schematic diagram of an embodiment in which the power inverter is located within the EVSE housing and the associated inverter battery is positioned in an external enclosure.

FIG. 7C is a schematic diagram of an embodiment in which the power inverter is located within the EVSE housing and receives power from a combined inverter battery and auxiliary battery housed within a main controller enclosure.

FIG. 8 is a schematic state diagram illustrating supervisory transitions among operating states of a power converter.

FIG. 9 illustrates an example voltage waveform variation showing amplitude-and frequency-related behavior of a power converter operating under supervisory control.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

A home energy system can include multiple energy-related components configured to deliver electrical power to a residence. The system may incorporate a utility connection, one or more distributed energy resources such as photovoltaic panels or a generator, a main service panel, and interfaces for coordinating loads, storage, and charging functions. The system may also include an electric vehicle and an associated electric vehicle supply equipment unit that enables charging of the vehicle's traction battery from the home.

When utility power is present, the home generally operates in a grid-connected mode. In this mode, the home receives alternating-current power through the main service panel, often provided as a split-phase supply including line conductors L1 and L2 and a neutral conductor. Many household devices are configured to operate on either the line-to-neutral voltage or the line-to-line voltage. Grid-connected operation provides the voltage and frequency reference for these devices, and inverters associated with photovoltaic or storage resources typically synchronize their output to this reference before connecting to the home.

A photovoltaic system can be coupled to the home's AC wiring. The PV system includes a DC-generating array and one or more inverters that convert DC from the array into AC that can be consumed locally or delivered toward the grid. These inverters operate by following an external AC reference. When utility power is present, the PV inverters detect the reference waveform and adjust their output accordingly. If the waveform is absent or unstable, the PV inverters generally cease AC production in accordance with standard operating requirements.

The EVSE is also connected to the home's AC wiring. When the vehicle is plugged in, the EVSE and the vehicle exchange signals through a communication protocol. During grid-connected operation, the EVSE receives AC power from the home, converts it to DC, and provides the resulting DC to the traction battery. Charging coordination may be handled by the EVSE or by a central energy management controller. The EVSE may further communicate with a utility or local PV controller for coordinated charging based on available solar output or time-based operating preferences.

If utility power becomes unavailable, the system transitions to an islanded mode in which the home is isolated from the utility grid. The external AC reference previously provided by the grid is no longer present. Components that depend on detecting an external reference, including certain PV inverters, may not operate without that reference and therefore typically suspend AC output. As a result, the PV system may remain inactive during an outage even when sunlight is available.

The system may include a power converter that is capable of generating its own AC output from a local energy source such as a vehicle battery. When energized, the power converter produces a voltage and frequency reference on the AC wiring. This reference can be used by grid-following devices, including PV inverters, to synchronize their output. Once the AC waveform is present, the PV inverters detect it and may initiate AC production. When the vehicle is connected and energy balance allows, PV-derived power may be directed toward charging the vehicle. The reference output produced by the power converter serves as the stabilization source relied upon by the PV inverters and other devices during islanded operation.

In some implementations, the system may further include a neutral-forming transformer that produces a synthetic neutral when the grid is disconnected. When a relay associated with the transformer is closed, the transformer establishes a reference point between L1 and L2 that supports loads configured for line-to-neutral operation. The transformer, in combination with the power converter, allows operation of loads that require either line-to-neutral or line-to-line connections during islanded conditions.

Depending on implementation, the power converter may be located in a dedicated enclosure, in the EVSE, or within the electric vehicle. In these various configurations, the converter provides AC output derived from a local DC source and interacts with other components of the home energy system.

System-level coordination may be managed by a home energy management controller or may be distributed across the EVSE, PV controller, and supervisory controller associated with the power converter. Control decisions may account for available PV output, the state of charge of the vehicle battery, the presence of local loads, or operating preferences defined by the user. When utility power returns, the system can detect the reappearance of the external AC reference and transition back to grid-connected operation. In this condition, the power converter may deactivate or enter a standby mode according to the supervisory controller's logic.

Additional configurations may incorporate coordinated control features that govern how converters interact during islanded operation. In these configurations, a supervisory arrangement may determine which converter operates at a given time, how an AC reference is established, and how downstream devices reconnect once bus conditions become suitable for operation. This supervisory behavior may extend across a home energy system, EVSE, and an EV, and may involve decisions informed by measured electrical conditions, converter availability, and energy-source readiness.

The supervisory arrangement may select a converter to provide an AC reference during islanded operation. A selected converter may generate a waveform that defines voltage magnitude and frequency on the AC bus. This reference may support operation of devices such as a PV inverter, which rely on the presence of an AC waveform before they begin delivering power. The supervisory arrangement may evaluate conditions such as the presence or absence of AC voltage, the readiness of individual converters, available energy within converter battery or a traction battery, and the presence of a vehicle connection. Based on these conditions, the supervisory arrangement may determine which converter is positioned to generate the reference and when that role should be assigned.

A converter that is not generating the reference may remain in standby until conditions indicate that it should participate. In standby, a converter may perform monitoring functions without energizing the AC bus. Standby may serve as the default condition when grid 22 is present or when islanded operation is not active. If a grid outage is detected, the supervisory arrangement may verify that the grid is isolated, confirm that internal relays are in the appropriate state, and identify a converter capable of generating a reference. Once readiness is established, the supervisory arrangement may activate the selected converter and initiate reference generation.

During reference generation, a converter may energize the AC bus with a waveform within voltage and frequency ranges designated by supervisory guidance. The converter's internal control loops may control instantaneous waveform behavior, while the supervisory arrangement evaluates high-level indicators such as voltage presence, frequency consistency, and converter readiness. Reference generation may continue until the supervisory arrangement determines that downstream devices can reconnect.

Once the reference is present and stable, the supervisory arrangement may enable reintegration of grid-following devices such as a PV inverter. Reintegration may depend on PV inverter detecting the reference through its internal controls and confirming that bus conditions fall within its operating requirements. After synchronization, the PV inverter may resume delivering power to the AC bus. This reconnection may occur autonomously within the PV inverter once supervisory conditions support its operation.

If more than one converter is available, the supervisory arrangement may authorize coordinated-output operation. In this configuration, one converter may maintain the reference while one or more other converters adjust their AC output to operate in a compatible manner. These coordinated-output converters may contribute power without generating an independent reference. Their participation may depend on SOC conditions, energy availability, load conditions, or real-time system requirements.

After PV reconnection, the supervisory arrangement may evaluate whether conditions support charging of an EV. Charging may be enabled when PV output is sufficient, when home load demands allow, and when SOC of a traction battery is suitable for accepting charge. Charging may occur through EVSE or through an onboard AC charger within the EV. The supervisory arrangement may verify AC bus stability, evaluate SOC thresholds, and confirm that the EVSE is ready to proceed before enabling charging. If conditions change, charging may be paused and resumed as permitted by supervisory logic and downstream device readiness.

Transitions among supervisory states may occur as system conditions evolve. If PV output varies, if one converter becomes unavailable, or if SOC conditions shift, the supervisory arrangement may reassign roles among available converters. If the AC reference becomes unstable or if fault conditions arise, converters may return to standby until conditions support reactivation.

When the utility grid returns, the supervisory arrangement may detect grid voltage and frequency through sensing at the home system. Once grid presence is verified, the supervisory arrangement may deactivate reference generation, deactivate coordinated-output participation, and perform relay sequencing to remove the islanded reference from the AC bus. In embodiments with a neutral-forming transformer, the supervisory arrangement may open an NFT relay as part of the restoration sequence. After the internal reference is removed, a main breaker may be closed to reestablish grid connection for the home.

Once grid restoration is complete, converters may return to standby with monitoring functions active. This allows the system to respond to subsequent outages without requiring manual intervention. The EVSE and PV inverter may resume their conventional grid-connected behavior, with the PV inverter following the utility waveform and the EVSE managing charging according to grid-connected charging logic. The supervisory arrangement may remain active during grid-connected operation to monitor system status and to prepare for future transitions.

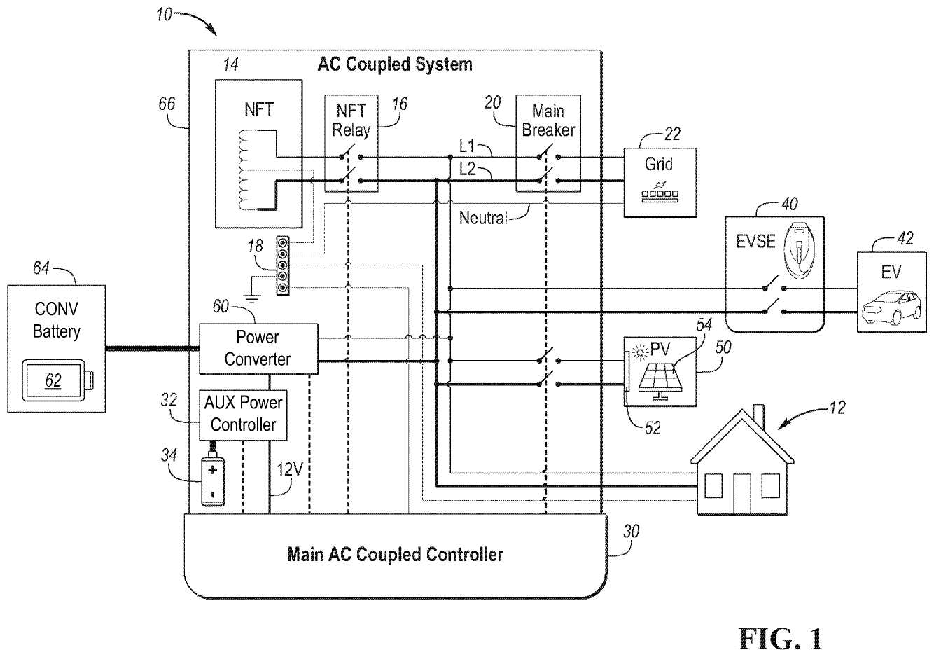

Referring to FIG. 1, an AC coupled system 10 of a home 12 includes multiple components that coordinate to deliver electrical power during grid-connected and islanded conditions. The system 10 includes a neutral-forming transformer 14 having a winding such as a center-tapped winding used to establish a synthetic neutral reference. The neutral-forming transformer 14 is electrically connected to line conductors L1 and L2 and includes a switch identified as the NFT relay 16. When the NFT relay 16 is closed, the neutral-forming transformer 14 connects to an AC bus 18 and produces a neutral reference between L1 and L2, supporting line-to-neutral operation during islanded conditions.

The grid 22 supplies L1, L2, and Neutral lines to the system 10 when utility power is present. A main breaker 20 connects L1 and L2 to the home 12. When grid 22 is available, the main breaker 20 is closed so that the home receives the external voltage and frequency reference. Grid-following devices within the system 10 respond to this reference. When utility power becomes unavailable, the main breaker 20 opens to isolate the home 12 from the grid 22 and prevent back feeding toward the utility.

The Neutral line is connected to the center tap of the neutral-forming transformer 14 and the neutral conductor originating from the grid 22. Within the system 10, the Neutral conductor is routed to load centers and distributed energy interfaces to provide a stable reference for loads that operate on line-to-neutral voltage.

The system 10 further includes an auxiliary power controller 32 associated with an auxiliary battery 34. The auxiliary battery 34 provides low-voltage DC power for operation of control circuits when utility power is absent. A low-voltage connection supplies the auxiliary battery 34 to a main controller 30 that contains control logic and relay-driving circuitry. The auxiliary battery 34 supports activation of elements such as relays and low-voltage control electronics in the absence of utility power, enabling the system to prepare components for islanded operation.

The main controller 30 functions as a coordination unit for relays, power sensing, and activation of equipment associated with the system 10. The main controller 30 is connected to the NFT relay 16, the main breaker 20, the auxiliary battery 34, and the AC bus conductors L1, L2, and Neutral. Through these connections, the controller 30 supports transitions between grid-connected and islanded modes and may exchange information with devices such as a photovoltaic inverter and the EVSE 40.

In some embodiments, the main controller 30 is implemented within a combiner box used to house electrical interfaces and control circuitry. The combiner box may include an enclosure containing cable routing pathways, terminal blocks, relays, fuses, circuit boards, and other components that support interconnection and coordination within the system 10. The enclosure may include environmental protection or internal segmentation for high-voltage and low-voltage wiring. The combiner box accommodates conductors for L1, L2, Neutral, and ground in addition to low-voltage wiring for communication and battery supply.

In the illustrated example, the combiner box houses or is electrically connected to the auxiliary battery 34, the power converter 60, and the NFT relay 16. The combiner box may distribute low-voltage supply from the auxiliary battery 34 to startup circuits associated with the power converter 60 and other electronics such as sensor conditioning circuits and relay actuators. The combiner box may also receive DC from the converter battery 62. The AC output from the power converter 60 is routed through conductors L1 and L2 to the AC bus 18, and neutral connections may be routed through the neutral-forming transformer 14.

In certain implementations, the combiner box includes circuitry to monitor voltage and frequency on the AC bus 18. This circuitry supports detection of the presence or absence of the external reference from grid 22 and may signal the supervisory controller associated with the power converter 60 when transitions between operating modes are appropriate. Relay control logic within the combiner box may actuate the NFT relay 16 in coordination with activation of islanded operation. For instance, when the supervisory controller determines that the power converter 60 is prepared to generate an AC reference, the main controller 30 may initiate closure of the NFT relay 16 to activate the neutral-forming transformer 14 and establish the reference for line-to-neutral loads. During grid-connected operation, the NFT relay 16 may remain open while the supervisory controller maintains the power converter 60 in a passive or monitoring state.

The combiner box may also function as a signaling hub for communication among components of the system 10. For example, the controller 30 may communicate with the EVSE 40 or with a PV inverter 52 to obtain operational status, available power indications, or charging readiness information. In implementations where vehicle state-of-charge data is available, the combiner box may receive such data from the EVSE 40 and coordinate decisions related to charging. The combiner box may direct relay activation or deactivation in response to changes in PV output, vehicle connection status, or user-defined operating preferences.

The combiner box may also support modular expansion. Additional wiring harnesses, communication ports, and sensor inputs may be incorporated to support new system features or alternative converter arrangements. Removable protective devices or diagnostic indicators may also be included. The combiner box may be installed as a standalone enclosure or may be co-located with the power converter 60 depending on integration requirements and available space.

The system 10 is connected to an electric vehicle supply equipment unit 40 through which an electric vehicle 42 may be coupled. The EVSE 40 may be mounted inside or outside the home 12 and is connected to the AC bus 18 for receiving AC power and delivering it toward the vehicle. The EVSE 40 may support exchange of control signals with the EV 42 to coordinate charging behavior and operational status information. The EVSE 40 may include internal electronics that manage charging and coordinate its behavior with other components of the system 10.

The EV 42 includes a traction battery configured to store energy for propulsion and other functions. When connected to the EVSE 40, the traction battery may receive AC-sourced charging power that is converted to DC through onboard electronics. In some implementations, one or both of the EVSE 40 and the EV 42 may include a power converter 60 available for use during grid outages.

The system 10 is electrically connected to a grid-following device such as a photovoltaic system 50. In other embodiments, the system 10 may additionally or alternatively be connected to other grid-following equipment including energy storage systems, microinverters, fuel cell systems, wind turbine inverters, or other AC-coupled sources that operate using an externally supplied voltage and frequency reference.

The photovoltaic system 50 includes a PV inverter 52 and a PV array 54. The PV array 54 includes one or more photovoltaic modules configured to convert sunlight into direct current and may be arranged in series, in parallel, or in a mixed configuration to achieve a desired voltage and current profile. The PV array 54 is electrically connected to the PV inverter 52, which converts the DC output of the array into alternating current suitable for delivery to the AC bus 18. The PV inverter 52 may operate as a central inverter, a string inverter, or a distributed inverter. In the illustrated embodiment, the PV inverter 52 provides AC output across conductors L1 and L2 and may rely on a neutral reference when 120V loads are present downstream.

During grid-connected operation, the PV inverter 52 receives an AC reference waveform from the utility grid 22. The PV inverter 52 synchronizes its output to match the external voltage and frequency and provides AC current on the AC bus 18. Power produced by the PV system 50 may be consumed by the home 12, delivered toward the EVSE 40 to support charging of the EV 42, or delivered toward the grid 22 when permitted. The grid 22 provides the reference waveform and a grounded neutral, and the neutral-forming transformer 14 remains inactive with the NFT relay 16 in an open state.

When the grid 22 becomes unavailable, the main breaker 20 opens and isolates the home 12. In this state, the AC bus 18 no longer carries the external voltage and frequency reference. As a result, the PV inverter 52 is unable to synchronize its output and automatically suspends AC production even when the PV array 54 continues to generate DC power. To restore PV operation during this condition, a power converter such as the power converter 60 of the system 10, the power converter 76 of the EV 42, or the power inverter 92 or power converter 96 of the EVSE 40 may be activated to generate an AC voltage and frequency reference across L1 and L2. When the system supports line-to-neutral loads, the NFT relay 16 may also be closed to activate the neutral-forming transformer 14, which establishes a grounded reference between L1 and L2. With both the AC reference waveform and the neutral reference present, the PV inverter 52 can detect the waveform and resume AC production during the grid outage. PV-generated power may then be utilized within the home 12 or provided toward the EV 42 through the EVSE 40.

Upon loss of grid power, the main breaker 20 opens and isolates the home 12 and connected components from the grid 22. This isolation prevents back feeding into the grid 22. Once isolated, the AC bus 18 does not carry an external reference, and grid-following devices such as the PV inverter 52 are not able to operate. The PV system 50 therefore remains inactive even when sunlight is available. The EVSE 40 may also be unable to initiate or continue AC-sourced charging of the EV 42 in the absence of a synchronized AC waveform.

To address the absence of an external voltage and frequency reference during a grid outage, the system 10 includes a power converter configured to generate an AC output waveform suitable for energizing the AC bus 18. Unlike grid-following devices, the power converter 60 is capable of producing an independent reference waveform that supports operation of downstream equipment such as the PV inverter 52 and the EVSE 40 when utility power is unavailable. By generating this reference, the power converter 60 enables local use of energy from PV or other sources during an outage.

In the illustrated embodiment, the power converter 60 is electrically connected to the AC bus 18 and is configured to generate a reference amplitude and frequency during periods when grid 22 is not present. The power converter 60 receives DC power from a converter battery 62 that supplies the high-voltage input used for AC generation. In some implementations, the power converter 60 interfaces with the auxiliary battery 34, allowing activation of control circuitry under low-power startup conditions when the converter battery 62 is not yet available or is isolated by internal contactors.

The power converter 60 may include a power electronics stage such as a bridge converter with switching devices and associated drive circuitry. These elements produce an AC waveform according to control signals issued by a supervisory controller. Voltage sensing, current sensing, and feedback circuits may be included to support adjustment of output amplitude and frequency. In some embodiments, the power converter 60 incorporates processing hardware, memory, communication interfaces, and programmed routines for evaluating system conditions and coordinating with other components. The power converter 60 may be mounted within its own enclosure or within a shared housing associated with the system 10, and either the converter 60 or the converter battery 62 may be located external to the enclosure of the main controller 30 depending on system layout.

During grid-connected operation, the power converter 60 may remain in a passive or monitoring state. The AC bus 18 receives its reference waveform from the grid 22 through the main breaker 20, and the PV inverter 52 operates as a grid-following device. The power converter 60 may monitor L1 and L2 using its own sensors or receive status information from the main controller 30. In some embodiments, the supervisory controller associated with the power converter 60 observes characteristics of the external waveform and determines whether the grid reference remains within expected ranges. A loss of the external waveform or a deviation outside the expected range may be interpreted as a grid outage. Alternatively, the main controller 30 may detect the outage and notify the power converter 60. When a loss-of-grid condition is identified, the supervisory controller transitions the power converter 60 from a monitoring state toward an active state suitable for generating the reference waveform.

In one embodiment, the converter battery 62 provides the primary DC source for the power converter 60. Upon detection of an outage, the supervisory controller may evaluate readiness conditions such as system isolation, converter battery voltage, and the presence of connected loads. When these conditions are satisfied, the supervisory controller may activate the power stage so that the power converter 60 begins generating an AC waveform on the AC bus 18 to support operation of the PV system 50 and EVSE 40.

In another embodiment, the power converter 60 is also connected to the auxiliary battery 34. The auxiliary battery 34 may supply low-voltage DC to activate logic circuits, gate drivers, or diagnostic routines before the converter battery 62 is connected. The converter battery 62 may initially be isolated by internal contactors or battery management controls. After internal readiness checks are completed, such as verification of available PV output or vehicle load presence, the supervisory controller may direct a controlled connection to the converter battery 62. The auxiliary battery 34 may also support brief activation of the power converter 60 during startup sequences or recovery events when the converter battery 62 is delayed in becoming available.

Once energized, the power converter 60 generates an AC output waveform across L1 and L2 on the AC bus 18. This waveform functions as the reference for downstream devices that require synchronization. In embodiments that support line-to-neutral loads, the supervisory controller may coordinate with the main controller 30 to close the NFT relay 16 and activate the neutral-forming transformer 14, which establishes a grounded reference between L1 and L2. The combined operation of the power converter 60 and the neutral-forming transformer 14 supports both line-to-line and line-to-neutral loads during islanded operation.

With the AC reference present, the PV inverter 52 may detect the waveform and resume AC production. The resulting PV energy can be used by the home 12 or provided toward the EVSE 40 for charging the EV 42. The supervisory controller or the main controller 30 may determine whether charging is appropriate based on operating parameters such as PV output, home load levels, or available state-of-charge information from the EV traction battery 70. For example, the controller may delay charging unless the traction battery SOC is below a threshold or unless available PV power exceeds local demand. In some implementations, the power converter 60 may adjust attributes of its output during startup to facilitate smooth synchronization by the PV inverter 52.

The power converter 60 may communicate with components of the system 10 using wired or wireless interfaces. These communications may include reporting of voltage, current, and frequency measurements, transfer of event information, or reception of configuration signals from the main controller 30 or the EVSE controller 98. The power converter 60 may also participate in sequencing when the grid 22 returns. When the main controller 30 detects restoration of the external waveform, it may notify the supervisory controller of the power converter 60 to discontinue production of the islanded reference. The power converter 60 may then reduce its output, open internal contactors, or shift back to a monitoring state. In some implementations, the power converter 60 may support restart logic to prepare for a subsequent outage.

In the embodiment shown in FIG. 1, the power converter 60 is electrically connected to the AC bus 18 at a point downstream of the neutral-forming transformer 14 and the NFT relay 16. In this arrangement, the output of the power converter 60 connects directly to L1 and L2 of the AC bus 18, while a neutral reference becomes available only when the NFT relay 16 is closed. If the NFT relay 16 remains open, the power converter 60 is not connected to the neutral point and may have limited ability to stabilize the AC waveform for downstream loads that require a grounded reference. In this configuration, startup and reference generation are coordinated with activation of the neutral-forming transformer 14. This arrangement may be used when operation of the power converter 60 and the neutral-forming transformer 14 is intended to follow a coordinated sequence managed by the main controller 30 or when it is preferred that the neutral reference be established before the AC bus 18 becomes energized.

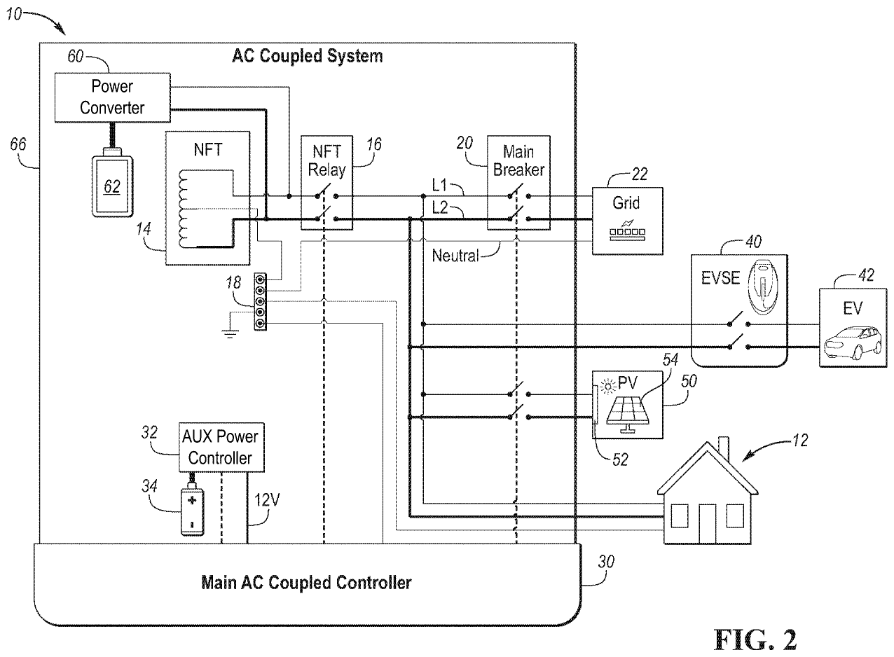

Referring to FIG. 2, in another embodiment, the power converter 60 is connected at a location electrically upstream of the NFT relay 16, closer to the winding of the neutral-forming transformer 14. In this arrangement, the power converter 60 is wired to the L1 and L2 conductors on the source side of the NFT relay 16, which allows the power converter 60 to begin generating an AC waveform upon activation even when the NFT relay 16 remains open. Because the power converter 60 is not dependent on the relay position to produce an AC reference, it can establish an output waveform on the upstream side of the circuit before the neutral-forming transformer 14 is engaged. This arrangement enables the supervisory controller associated with the power converter 60 to energize the upstream conductors, observe operating conditions, and perform readiness evaluations before energizing the full split-phase architecture of the system. Such evaluations may include internal diagnostics, detection of available PV power, or confirmation that the system is electrically isolated from the grid 22. This configuration may also be useful in systems where activation of the neutral-forming transformer 14 occurs in a staged sequence or is managed independently from the switching behavior of the power converter 60.

Referring again to FIG. 1, the power converter 60 is shown installed within a housing of the system 10. The power converter 60 is electrically coupled to the AC bus 18 and is configured to generate an AC reference during a grid outage to support operation of the PV system 50 and charging of the EV 42. The power converter 60 may be physically located near the auxiliary power controller 32 and auxiliary battery 34 or positioned in a separate region of the system 10. In some versions, the power converter 60 is electrically coupled to the auxiliary power controller 32, which supports activation of low-voltage electronics, startup sequencing, and energization of logic circuits. In other versions, the power converter 60 and the auxiliary power controller 32 are separated within the housing but exchange signals through internal connections to support coordinated sequencing when grid power is unavailable.

The converter battery 62 may be located external to the system 10 and housed in a separate enclosure 64. This external placement may be useful in installations where the converter battery 62 requires dedicated thermal management or where system retrofitting conditions limit placement within existing housings. An external converter battery 62 may also support modular or field-replaceable configurations, allowing battery capacity to be updated or exchanged independently of the remainder of the system 10. The power converter 60 may be connected to the converter battery 62 by a high-voltage DC link and may receive activation or operating commands from the controller 30 when the system transitions to islanded operation.

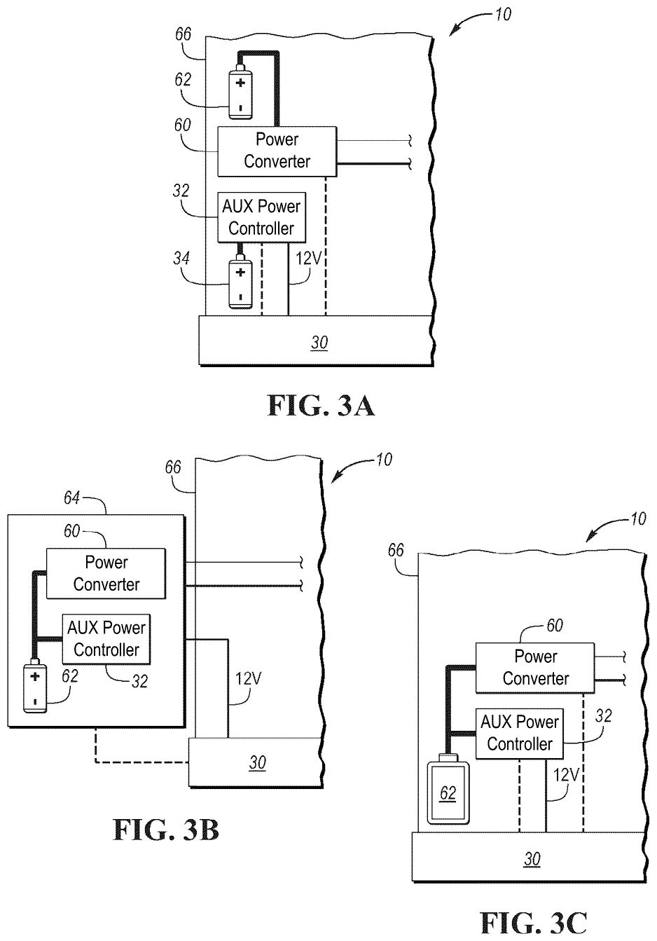

Referring to FIG. 3A, in another embodiment, the power converter 60, converter battery 62, auxiliary power controller 32, and auxiliary battery 34 are housed within the system 10. This arrangement provides an integrated configuration in which the components associated with AC reference generation and low-voltage startup support are contained within a common enclosure 66. In applications where the enclosure 66 is designed with suitable volume and thermal characteristics, this integrated layout may simplify internal routing, reduce the number of external interfaces, and strengthen coordination between the power converter 60 and the main controller 30.

Referring to FIG. 3B, in another embodiment, the power converter 60, the converter battery 62, and the auxiliary power controller 32 are located external to the system 10 and housed within a shared enclosure 64. In this configuration, the converter battery 62 supplies high-voltage DC to the power converter 60 and also supports low-voltage operation of the auxiliary power controller 32. The auxiliary power controller 32 may energize logic circuits and startup components when grid power is unavailable. The power converter 60 is connected to the AC bus 18 and may begin generating an AC reference when the controller 30 directs activation. Placement in a shared external enclosure 64 may be useful where system 10 is space constrained or where a modular structure is preferred for field installation, battery replacement, or equipment upgrades.

Referring to FIG. 3C, in another embodiment, the power converter 60, the converter battery 62, and the auxiliary power controller 32 are located within the system 10. In this configuration, the converter battery 62 supplies high-voltage DC for operation of the power converter 60 and low-voltage DC for auxiliary functions. The main controller 30 coordinates detection of grid status, startup behavior of the power converter 60, and sequencing of relays during transitions between grid-connected and islanded operation. This arrangement may be used when the system architecture is designed as an integrated assembly, providing coordinated thermal management, shielding, and internal power routing.

A supervisory volt-frequency control arrangement may be incorporated into the system to guide the behavior of one or more power converters during conditions in which an external voltage or frequency reference is unavailable or unsuitable for direct use. This arrangement operates at a level above the internal voltage and current control loops of each individual converter and coordinates the actions of converters located in different portions of the overall energy system. These converters may include a converter integrated into system 10, a converter associated with an EVSE, or a converter positioned within an EV. Each of these converters is capable of contributing an AC output to the AC bus under selected conditions, and the supervisory control arrangement determines which of these converters should act as the active source of the AC reference at any given time.

The supervisory control arrangement receives information from components distributed across the system. This information may describe whether an external AC reference is present on the AC bus, whether a converter within the system is already producing a reference, whether an EV is connected, or whether a PV inverter is available to deliver power once a reference is reestablished. Additional information may include the state of contactors or relays within the system, the state of charge of energy sources such as an EV traction battery, and the presence or absence of AC bus voltage generated by upstream power equipment. Using this information, the supervisory control arrangement selects an operating state consistent with the conditions on the AC bus and with the availability of converters capable of generating or coordinating with an AC reference.

The supervisory control arrangement may be implemented within a single controller or in a distributed manner. In one configuration, logic associated with main controller 30 manages these supervisory functions. In other configurations, a controller within an EVSE may perform this role, or supervisory logic may be positioned within an EV. The supervisory control arrangement remains functionally similar across these implementations. It interprets electrical and operational conditions, manages converter activation and deactivation, and directs converters to operate in reference-generation or coordinated-output roles.

The supervisory control arrangement also interacts with devices that operate in a grid-following mode. PV inverters and certain forms of vehicle charging electronics rely on an externally supplied AC reference to initiate and sustain operation. When a suitable reference is not present, these devices do not contribute power to the AC bus. The supervisory control arrangement responds by directing a selected converter to provide the AC reference so that grid-following devices may resume operation. Once the reference is present, these grid-following devices may detect the waveform and synchronize their outputs to it.

The supervisory control arrangement observes a range of operating conditions in order to transition between states. These conditions include the presence or absence of a voltage waveform on the AC bus, the stability of the observed frequency, the status of relays that route power to or from the AC bus, and the availability of PV or EV energy sources. The supervisory control arrangement may also consider the connection state of an EV, the state of charge of the EV traction battery, and the readiness of an EVSE converter to contribute power. By interpreting these conditions, the supervisory control arrangement determines whether to remain in a monitoring state, initiate a reference-generation state, or coordinate the output of a converter with an existing reference.

The supervisory volt-frequency control arrangement may be implemented within different portions of the overall energy system. In some configurations, the supervisory logic is located within the main controller of system 10. In other configurations, the supervisory logic is positioned within an EVSE controller or within logic associated with an EV. These placement options allow the supervisory arrangement to coordinate the behavior of converters located across the system without requiring a specific hardware enclosure. In still other versions, supervisory functions may be distributed across several controllers, with each controller processing a portion of the decision logic and exchanging information with other controllers over available communication links.

The supervisory arrangement receives information that describes electrical and operational conditions within the system. This information may include indications of whether AC voltage is present on the AC bus, whether the observed AC frequency is stable, or whether contactors and relays associated with the system are in an open or closed state. Additional inputs may include readiness signals from converters, data indicating whether an EV is connected, the state of charge of energy sources such as an EV traction battery or converter battery, and information from PV inverters describing their availability to operate once an AC reference is present. Fault status information or internal diagnostic indicators from converters or controllers may also be provided. These inputs may be in the form of raw sensor values, discrete signals, or state information supplied over communication pathways.

Based on this information, the supervisory arrangement produces commands for participating converters and for other components within the system. These commands may direct a converter to enter a reference-generation role, a coordinated-output role, or a standby state. Commands may also initiate or suspend charging, or sequence the activation of relays associated with islanded operation. For example, the supervisory arrangement may send an enable signal to a converter designated to provide the AC reference or may hold a converter in standby while another converter is active. These commands may be represented as digital control signals or as communication messages transmitted over an appropriate interface.

Participating converters may include a converter associated with system 10, a converter within an EV, or a converter associated with EVSE 40. Each converter includes its own power control stage and internal control loop but relies on supervisory direction for determining whether it should generate the AC reference or coordinate its output with an existing reference. The supervisory arrangement does not modify the internal switching behavior of these converters. Instead, it determines when a converter should energize the AC bus, when it should adjust its output to align with a reference waveform, and when it should deactivate to support orderly transitions among system states. A converter designated as the reference source may produce an AC waveform that serves as the reference for grid-following devices.

The supervisory arrangement may also interact with relays and switching components that influence AC bus configuration. These components may include the neutral-forming transformer and associated relay, as well as contactors within the EVSE used for routing power between the AC bus and the EV. The supervisory arrangement may consider the state of these relays when determining whether to activate a converter or when sequencing transitions between states. For example, a converter may remain in standby until conditions indicate that the AC bus is electrically isolated from external sources and internal relays are in positions consistent with islanded operation.

The supervisory arrangement also interfaces indirectly with grid-following devices. PV inverters and vehicle chargers depend on the presence of an AC reference before contributing power to the AC bus. When the supervisory arrangement selects a converter to generate the reference, the resulting waveform supports continued operation of these grid-following devices. The supervisory arrangement may also withhold converter activation until PV output or other energy sources are available to support expected load conditions.

The supervisory arrangement may be implemented in centralized form or in distributed form. In a centralized implementation, a single controller may receive all necessary information and issue all supervisory commands. In a distributed implementation, individual controllers may each perform a portion of the supervisory logic and exchange information to reach compatible decisions regarding converter activation and role assignment. Distributed implementations may also support coordination among converters in situations where two converters are available to operate on the AC bus.

Through this supervisory guidance, the system is structured to initiate and maintain an AC reference during islanded conditions, coordinate the participation of multiple converters where present, and support the operation of grid-following components once a suitable reference is available. The supervisory control arrangement therefore establishes a high-level decision layer that influences converter activation, role assignment, and transitions among operating states without altering the internal control behavior of the converters themselves.

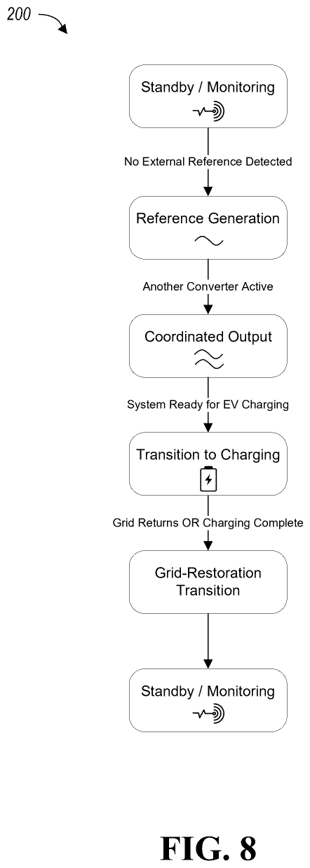

The supervisory volt-frequency control arrangement may operate according to a state-based structure that coordinates converter behavior during grid-connected and islanded conditions. FIG. 8 illustrates an example set of operating states 200 that may be used for supervisory decision-making. Each state reflects a functional mode in which converters may be inactive, assigned to generate an AC reference, assigned to coordinate their output with a reference produced elsewhere, or authorized to support charging. Transitions among states may depend on the presence or absence of a suitable reference on the AC bus, relay positions, converter readiness, or information associated with connected devices such as an EV or PV system.

In a standby or monitoring state, the supervisory arrangement observes conditions on the AC bus without directing any converter to generate the AC reference. During this state, the supervisory arrangement may evaluate whether voltage is present on the AC bus, whether the observed AC frequency is stable, whether an EV is connected, or whether energy sources such as a PV system or an EV traction battery are available to support islanded operation. The supervisory arrangement may also observe relay or contactor positions and internal readiness conditions associated with converters. Converters remain inactive in this state, and the supervisory arrangement waits for a condition that requires converter participation.

When the supervisory arrangement determines that the system should generate an AC reference, a converter may be directed to enter a reference-generation state. In this state, a converter associated with system 10, an EV, or an EVSE may energize the AC bus and produce an AC waveform that functions as the reference for other devices. Downstream grid-following devices such as PV inverter 52 may detect this waveform and resume operation. The supervisory arrangement may continue to monitor system conditions during reference generation and may transition to other states when conditions change.

In some configurations, another converter may become available or may require coordination with the converter already producing the AC reference. In these circumstances, the supervisory arrangement may enter a coordinated-output state. During coordinated output, a single converter continues to serve as the reference source, and another converter aligns its AC output with the reference. Alignment does not require any specific control method and may generally involve adjustment of the converter's output so that it operates compatibly with the reference waveform. The coordinated-output state supports participation of more than one converter under supervisory guidance. The supervisory arrangement may remain in this state until it determines that a different configuration is appropriate, such as when PV charging is authorized or when the system transitions to a charging state.

When conditions support vehicle charging, the supervisory arrangement may enter a transition-to-charging state. During this state, a reference remains present on the AC bus, and the supervisory arrangement may authorize charging of a connected EV using available PV power or power supplied by an active converter. Charging may depend on factors such as the state of charge of the EV traction battery or the availability of PV output. The supervisory arrangement may also monitor whether the AC reference remains stable during charging. Departure from this state may occur when charging criteria change, when PV output declines, or when another converter transition is required.

A grid-restoration transition may occur when the supervisory arrangement detects that the utility AC waveform has returned. During this state, the supervisory arrangement evaluates whether the restored grid waveform is suitable for system reconnection. Converters operating under supervisory direction may be deactivated or shifted to a passive role. Relays that isolate the AC bus from the utility grid during islanded operation may be sequenced to reconnect the home to the grid. Grid-following devices may then resume operation using the restored grid waveform. Upon completion of this transition, the supervisory arrangement may return to the standby or monitoring state.

The supervisory volt-frequency control arrangement may transition between operating states 200 based on changes in electrical and operational conditions within the system. FIG. 8 illustrates an example sequence that may be used to guide these transitions. The supervisory arrangement evaluates information from the AC bus, converters, relays, and associated devices, and selects a state consistent with the observed conditions. These transitions do not depend on converter-level switching dynamics and instead occur at a supervisory level that responds to broader system behavior.

The supervisory arrangement may detect the loss of a suitable AC reference by observing the absence of voltage or the absence of a stable frequency on the AC bus. A transition from the standby or monitoring state to a reference-generation state may occur when these conditions indicate that the grid is no longer supplying a usable waveform. Relay and contactor positions within the system may also indicate isolation from the grid and may contribute to supervisory decisions to initiate reference generation.

Transitions may also depend on the readiness of converters available to participate in reference generation. A converter may signal readiness through internal diagnostics, state information from its battery system, or indications that its contactors or protection elements are in suitable positions for operation. When a converter becomes ready, the supervisory arrangement may assign it to generate the AC reference or may prepare it for coordinated-output operation depending on conditions present on the AC bus.

If the supervisory arrangement determines that another converter is already producing a reference, it may hold additional converters in standby or may assign one or more converters to coordinated-output roles. Detection of another active converter may be based on evaluation of the AC waveform on the bus or on information exchanged among controllers. This detection prevents more than one converter from independently attempting to energize the AC bus unless coordinated participation is appropriate.

Availability of PV output may influence transitions into or out of certain states, particularly reference generation and charging. PV availability may be indicated by the status of a PV inverter or by other information describing whether the PV system can contribute energy once a suitable AC reference is restored. The supervisory arrangement may allow charging in the presence of PV output or may delay charging until PV availability reaches a threshold.

The detection of an EV connection may also influence state transitions when charging or participation of an EV-based converter is possible. The supervisory arrangement may consider plug-in status, EVSE contactor state, or communication from the EV indicating whether charging or grid-support behavior is permissible. These conditions may cause transitions into coordinated-output or charging-related states, or may influence which converter is selected to produce the AC reference.

Battery state-of-charge information may further guide supervisory decisions. SOC values may determine whether a converter associated with an EV or with system 10 is authorized to generate the reference or to support charging. SOC thresholds may cause transitions into or out of a charging state or may affect the choice of which converter should serve as the active reference source.

Relay and contactor positions may determine whether a converter can properly energize the AC bus. These positions may include those of the neutral-forming transformer relay, contactors within the EVSE, or internal converter contactors. The supervisory arrangement may verify these positions prior to activating a converter or before permitting transitions into states that require AC bus energization.

Restoration of the utility grid may lead to a transition into the grid-restoration state. This transition may occur when the supervisory arrangement detects return of voltage on the AC bus or detects the presence of a frequency generated by the grid. During this state, converters operating under supervisory direction may deactivate, and relays that isolate the AC bus may be sequenced to reconnect the system to the grid. Once reconnection is complete, grid-following devices may resume using the utility waveform, and the supervisory arrangement may return to the standby or monitoring state.

When conditions indicate that converters are inactive and the AC bus is energized by the grid, the supervisory arrangement may return to standby, completing the supervisory cycle. These transition triggers allow the supervisory arrangement to respond to changing conditions and to guide converter participation in a manner consistent with the operating states 200 illustrated in FIG. 8.

When the supervisory volt-frequency arrangement assigns a converter to a reference-generation role, the selected converter produces an AC waveform on the AC bus that functions as the local voltage and frequency reference for downstream devices. This reference may be used by grid-following components such as PV inverter 52 and by other converters that participate in coordinated-output operation. The supervisory arrangement determines the conditions under which reference generation begins, while the converter's internal control circuits govern the real-time synthesis of the waveform.

The supervisory arrangement may specify voltage ranges suitable for operation during islanded conditions. These ranges may be selected to support downstream equipment that depends on the presence of an AC reference before contributing power. The converter's internal voltage control loop maintains instantaneous waveform characteristics within these supervisory bounds. The converter may utilize any internal control method capable of producing a compatible AC output.

The supervisory arrangement may also specify a frequency range for reference operation. The converter's internal control circuitry manages the precise frequency of the generated waveform within this range. The supervisory arrangement may observe high-level indicators of frequency stability and may use this information to determine whether conditions support transitions into coordinated-output or charging states.

Interaction between the supervisory arrangement and the converter's internal loops occurs through high-level directives. These directives may include activation or deactivation commands, selection of operating roles, and authorization to energize the AC bus. The converter's internal loops perform the real-time voltage and current control needed to synthesize the waveform. Supervisory logic therefore influences when and under what conditions the converter participates, rather than altering the converter's internal control behavior.

When a converter enters the reference-generation state, it may activate internal contactors or related components and begin producing the AC waveform. The supervisory arrangement may transition into subsequent states only after a stable reference is detected through voltage and frequency indicators. During this period, the supervisory arrangement may determine whether PV output is available, whether coordinated participation from another converter is suitable, or whether charging conditions are met.

The AC reference generated in this state may be used by grid-following devices that require a voltage and frequency reference to operate. For example, PV inverter 52 may detect the reference waveform and resume its operation, which may include exporting AC power onto the AC bus. Once the reference is established, downstream devices may initiate their respective operating modes in accordance with their own internal control logic.

During coordinated-output conditions, one converter maintains the reference waveform while another converter aligns its output with the reference. Supervisory guidance maintains the assignment of these roles and supports operation within voltage and frequency ranges suitable for multi-converter participation.

The supervisory arrangement may confirm the integrity of the reference through high-level indicators such as voltage presence, frequency consistency, or the absence of converter fault reports. If these indicators reveal that the reference is no longer suitable for continued operation, the supervisory arrangement may deactivate the converter, return to a monitoring state, or designate another converter to produce the reference.

Once a stable reference is established, the supervisory arrangement may authorize transitions into coordinated-output or charging states. If the utility grid returns, the supervisory arrangement may initiate a transition into the grid-restoration state discussed previously.

In some configurations, more than one power converter may be available to participate on the AC bus. These converters may be associated with system 10, EVSE 40, or EV 42. The supervisory volt-frequency arrangement evaluates which converters are present, which have access to energy sources, and which are capable of contributing to islanded operation. Based on these conditions, the supervisory arrangement assigns one converter to generate the AC reference waveform while directing one or more other converters to contribute through coordinated output.

Availability of a converter may be determined using indicators such as readiness signals, hardware status information, connection state, or the state of charge of an associated energy source. For example, a converter within the EV 42 may be considered available only when the EV is coupled to the EVSE 40, while a converter within system 10 may be considered available whenever the auxiliary battery 34 or converter battery 62 can support startup logic. The supervisory arrangement may continually evaluate such conditions to determine whether one converter or another should serve as the reference source.

The supervisory arrangement may select a reference-producing converter based on factors such as energy availability, the presence of neutral-forming equipment, or the relative readiness of converters within the system. A converter with access to a stable high-voltage source may be selected to generate the reference, while another converter with a lower state of charge may be assigned to a coordinated-output role. In some cases, the physical location of the converter may support selection; for example, a converter integrated into system 10 may be preferred when the neutral-forming transformer 14 is active.

A converter operating in a coordinated-output role may adjust its AC output so that it operates compatibly with the generated reference waveform. Coordination may include operating within voltage and frequency ranges suitable for multi-converter participation. The coordinated converter may contribute power to the AC bus without generating an independent reference.

The supervisory arrangement may reassign converter roles as conditions change. Role reassignment may occur when a converter becomes unavailable, when energy-source state of charge thresholds are crossed, when a converter fault signal arises, when PV availability increases or declines, or when charging begins or ends. Reassignment may also occur when the utility grid returns and the system transitions to the grid-restoration state. The supervisory arrangement may select a new reference-producing converter or deactivate coordinated participation based on these state changes.

To maintain stable operation, the supervisory arrangement may prevent multiple converters from generating independent AC references at the same time. This may include directing converters to remain in standby when a valid reference is present on the AC bus, or instructing converters to enter a coordinated-output role instead of producing a reference. If a converter is not suited to operate during a particular condition, the supervisory arrangement may direct it to deactivate or remain passive until conditions change.

In some implementations, more than one converter may operate concurrently on the AC bus while maintaining structured participation. One converter produces the reference waveform, and one or more additional converters contribute power while operating within supervisory limits. Each converter maintains its internal control loops while the supervisory arrangement coordinates their high-level roles.

Distributed coordination logic may be used in addition to or instead of centralized control. Converters may communicate with one another or with the main controller 30 to share operating conditions, identify whether a reference is present, and determine whether coordinated participation is appropriate. The supervisory state transitions illustrated in FIG. 8 may be handled by a single controller or by a distributed set of controllers that share available information.

Coordinated behavior may occur during several portions of the operating cycle shown in FIG. 8. For example, coordinated output may follow initial reference generation, may occur while PV inverter 52 resumes operation, and may continue during vehicle charging. When the utility grid returns, the supervisory arrangement may shift converters back to a passive or monitoring state, deactivate reference production, and prepare the system to reestablish connection to the grid.

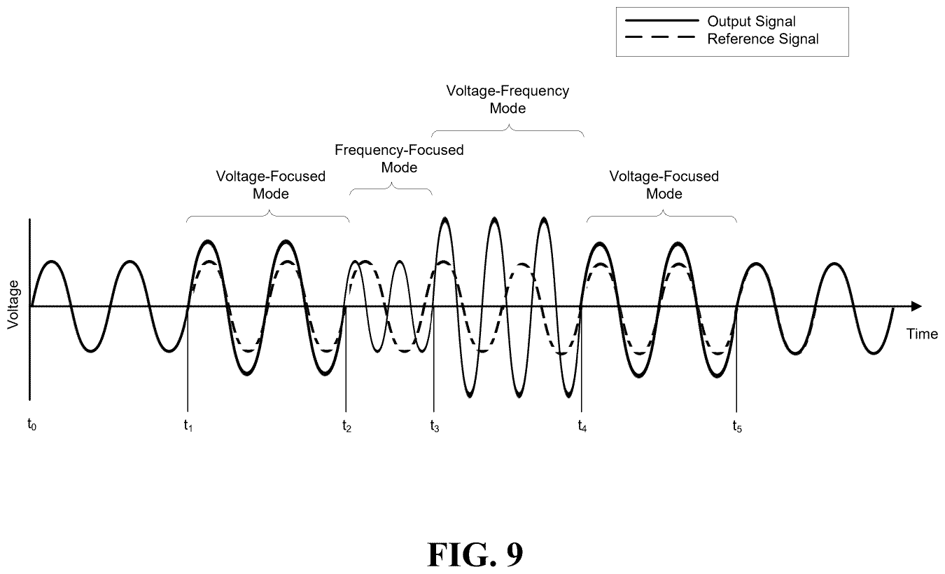

The system may incorporate a supervisory control arrangement that directs operation of a power converter during islanded conditions. When the AC bus is without an external voltage source, the supervisory controller initiates local waveform generation by the converter and dynamically adjusts converter behavior based on real-time conditions measured on the bus. FIG. 8 illustrates a state-based structure that supports this operation, and FIG. 9 presents representative waveform examples associated with these operating states and transitions.

During an islanded condition, the power converter energizes the AC bus with an AC waveform that defines both the bus voltage and the bus frequency. This locally generated waveform functions as the reference for downstream devices such as PV inverters, EV chargers, or household loads. The supervisory controller continuously measures electrical behavior on the AC bus and evaluates whether the converter output remains within voltage and frequency stability ranges defined for the system. When conditions deviate from these ranges or approach limits associated with expected bus behavior, the controller adjusts how the power converter contributes real power, reactive power, or both. This adaptive behavior supports continued operation of grid-following devices and maintains power delivery to household loads.

The supervisory controller may direct the power converter to operate according to one of multiple control modes. The first category includes modes in which only one control axis is primarily adjusted. In a voltage-focused mode, the converter adjusts a voltage-control parameter to influence the bus voltage while maintaining the bus frequency within a defined stability range. In a frequency-focused mode, the converter adjusts a frequency-control parameter to influence the bus frequency while maintaining the bus voltage within its stability range. A combined control mode is available when either single-axis mode cannot maintain both bus voltage and bus frequency within their corresponding limits. In the combined mode, the converter adjusts both the voltage-control parameter and the frequency-control parameter in a coordinated manner. The supervisory controller selects these modes based on sensed load behavior, stability thresholds, and internal evaluation of operating conditions.

FIG. 9 illustrates an example of waveform behavior associated with mode transitions. The solid line represents the output of the power converter. The dashed line represents a baseline waveform presented for comparison. The horizontal timing markers (t0, t1, t2, t3, etc.) identify periods in which different control modes are active.

At time t0, the converter begins generating an AC waveform to energize the AC bus. The baseline waveform is shown as a sinusoidal signal having a nominal amplitude and nominal frequency. The converter operates in a neutral or standby state during this initial phase, maintaining both voltage and frequency within their stability ranges without compensating for disturbances.

At time t1, a load-related condition occurs, such as an increase in reactive-power demand or a deviation in the bus voltage. The supervisory controller interprets the measured behavior and selects a voltage-focused mode. The converter adjusts a voltage-control parameter to increase or decrease the amplitude of the output signal while maintaining the output frequency near the nominal value. In FIG. 9, this is reflected by the solid waveform exhibiting a modified amplitude relative to the dashed baseline waveform.

If the load-related condition involves a frequency deviation or a rapid change in real-power demand rather than a voltage deviation, the controller may instead select the frequency-focused mode at time t1. In this case, the converter adjusts a frequency-control parameter to modify the frequency of the output waveform while maintaining the bus voltage within its stability range. The amplitude remains aligned with the baseline while the frequency shifts slightly. Either branch may occur depending on the disturbance type.

At time t2, the supervisory controller determines that the first control mode is unable to maintain both the voltage and frequency within their respective stability ranges. For example, the voltage-focused mode may reach a point where the voltage-control parameter saturates, or the bus frequency may begin drifting outside its allowed range. Similarly, during the frequency-focused mode, the converter may stabilize frequency but leave the voltage outside its acceptable window. In response, the controller transitions the converter into the combined control mode. In FIG. 9, the combined mode is represented by changes to both the amplitude and frequency of the solid waveform relative to the dashed baseline waveform.

During the combined control mode, the converter adjusts both the voltage-control parameter and the frequency-control parameter. This simultaneous adjustment supports stabilization of the bus voltage and the bus frequency when individual-axis adjustments are insufficient. The combined mode may also include a soft transient process in which the controller applies gradual changes to real and reactive power to prevent overshoot, excessive current, or abrupt changes on the AC bus.

At time t3, once both the bus voltage and the bus frequency return to their stability ranges, the controller may direct the converter to transition out of the combined control mode. Depending on operating conditions, the converter may return to the prior single-axis mode or may enter a steady-state mode in which both voltage and frequency drift very slightly but remain within defined allowable regions. If conditions continue to stabilize, the converter may eventually return to an unadjusted operating state similar to that shown around time t0.

In the voltage-focused mode, the supervisory controller adjusts a voltage-control parameter associated with the converter. This parameter may be implemented as a voltage setpoint, a droop-control slope, a reactive-power contribution, or another converter-internal quantity that influences the amplitude of the output waveform. The controller selects this mode when sensing conditions indicate that the bus voltage is outside a voltage stability range or exhibiting a rate-of-change behavior that warrants correction. The frequency remains within a corresponding stability range during this mode.

In the frequency-focused mode, the supervisory controller adjusts a frequency-control parameter. This parameter may be a frequency setpoint, a droop-control slope for frequency behavior, or another converter-internal quantity that influences the oscillation frequency of the output waveform. The controller selects this mode when measured data indicates that the frequency deviates from the stability range or exhibits a rate-of-change characteristic that calls for adjustment. The output amplitude remains within the voltage stability range during this mode.

The combined control mode is activated when either single-axis control mode is unable to maintain both the bus voltage and the bus frequency within their respective stability ranges. In the combined mode, the supervisory controller adjusts both the voltage-control parameter and the frequency-control parameter concurrently. Adjustment may occur through modification of active-power delivery, reactive-power delivery, or both. The combined mode may include application of a soft transient adjustment that limits the rate at which these parameters change. This coordinated control helps maintain converter operation within appropriate boundaries while responding to disturbances that affect multiple electrical quantities simultaneously.

The supervisory controller evaluates several types of load-related conditions. These may include deviations in bus voltage, deviations in bus frequency, a rate of change of bus voltage (dV/dt), a rate of change of bus frequency, real-power step changes, and reactive-power step changes. Each of these conditions may be compared against one or more thresholds stored in the controller memory. These thresholds may be preset, dynamically updated, or determined through learning processes based on historical load data.

The system maintains stability ranges for voltage and frequency. These ranges may be defined to correspond to acceptable operating windows for downstream loads or grid-following devices. The stability ranges may be stored in memory used by the supervisory controller. The controller evaluates whether measured values fall outside these stability ranges or approach boundary conditions that would prompt mode changes.

The supervisory controller selects the voltage-focused mode or frequency-focused mode based on real-time evaluation of load-related conditions. For example, the controller may enter the voltage-focused mode when the deviation of the bus voltage exceeds a threshold or when reactive-power demand on the bus exceeds a certain level. The controller may enter the frequency-focused mode when the deviation of the bus frequency exceeds a threshold or when the rate of change of frequency exceeds a specified limit.

Transitions occur when the supervisory controller determines that the current operating mode cannot maintain both the bus voltage and the bus frequency within their stability ranges. This determination may be based on persistent deviation, parameter saturation, or concurrent deviations of voltage and frequency. The controller then directs the converter to operate in the combined mode. When the combined mode has stabilized the system and both electrical quantities return to their stability ranges, the controller may return to one of the single-axis modes or to a steady operating state.

The controller may support multi-stage transitions such as entering one of the single-axis modes, switching to the other single-axis mode, and then entering the combined mode. These transitions may be determined based on the specific sequence and magnitude of bus disturbances.

The supervisory controller may implement a soft transient process during transitions into the combined mode or between other modes. This process uses rate-limited adjustments to real and reactive power to reduce electrical stress on converter components and maintain stable operation. The soft transient behavior may limit the slope of changes applied to voltage-control parameters and frequency-control parameters. The process may occur over a defined interval and may assist with shaping the converter output waveform in a manner that reduces overshoot.

The system may record load signatures and associated bus behavior in memory. The supervisory controller may update mode-selection thresholds and stability ranges based on these recorded signatures. The collected data may include load magnitude, load response time, reactive demand, impedance-related behavior, or other indicators of bus characteristics.

The controller may anticipate future load-related conditions using learning-based techniques. For example, it may identify patterns in household load behavior or time-of-day behavior associated with PV generation. The controller may adjust mode-selection parameters to support improved response to future disturbances. The controller may estimate impedance of bus components based on measured load behavior and update droop slopes or other parameters accordingly.

In configurations where the power converter resides within a home-energy-management enclosure, the converter may be directly connected to sensing equipment for voltage and frequency on the AC bus. An auxiliary power source inside the enclosure may support supervisory control during islanded conditions.

When the power converter is located within EV supply equipment, the supervisory controller may reference a vehicle interface signal indicating a charging state or a connected state. These signals may influence the selection of control modes or adjustment of control parameters.

When the power converter is located within an electric vehicle, the converter may draw power from a traction battery. The supervisory controller may reference measurements from onboard components such as the vehicle controller, battery management system, or charging interface. These references may inform selection of the first control mode or transitions into the combined mode.

The system may include a photovoltaic inverter or other grid-following devices connected to the AC bus. The supervisory controller may select the first control mode or adjust thresholds based on real-power contribution from these devices. For example, during high PV output, the system may prioritize frequency stabilization, while lower PV output conditions may prompt heightened prioritization of voltage stabilization. Additional control logic may coordinate converter behavior with multiple potential sources of islanded waveform generation.

In this way, and referring again to FIG. 8, the supervisory volt-frequency arrangement may transition among several operating states 200 as system conditions evolve. These states 200 include standby, reference generation, coordinated-output participation, vehicle charging, and grid restoration. FIG. 8 illustrates these states 200 in a conceptual form and depicts the general progression among them. Each transition may occur automatically based on monitored signals, communication inputs, or internal readiness indicators.

The supervisory arrangement may evaluate a variety of inputs when determining whether to transition into a new state. These inputs may include the presence or absence of AC voltage on the bus, frequency measurements, readiness indicators from converters, connection status of EV 42, available PV output from PV inverter 52, and state-of-charge information for traction battery 70 or converter battery 62. Additional factors may include temperature limits, protective conditions, or communication status among controllers. These inputs may be derived from direct sensing or from control messages exchanged among system components.

A converter may remain in standby when the utility grid is present or when conditions do not warrant converter participation. In this state, the supervisory arrangement may monitor AC bus conditions while keeping converters inactive except for essential monitoring functions. Standby may also serve as a fallback state during unexpected operating conditions or fault events.

A transition into reference generation may occur when the supervisory arrangement confirms that the utility grid is not present, that the home is electrically isolated, and that a converter with sufficient energy availability is ready to produce an AC reference. The supervisory arrangement may evaluate readiness of neutral-forming equipment, where applicable, before energizing the AC bus. Once these conditions are satisfied, the supervisory arrangement may issue an activation directive to a selected converter, designating it as the reference-producing converter.

Before transitioning out of reference generation, the supervisory arrangement may verify that the generated reference meets voltage and frequency expectations. These checks may include detection of AC voltage on the bus, confirmation that the measured frequency is within the supervisory range, and confirmation that the reference-producing converter reports a ready state. These verifications help confirm that downstream devices, such as PV inverter 52, may resume operation.

The supervisory arrangement may transition into a coordinated-output state when a second converter becomes available to contribute to the AC bus. Once a stable reference is present, a coordinated converter may be enabled to produce an AC output compatible with the reference. The coordinated converter may remain in this role as long as conditions support multi-converter participation, or until system inputs indicate that participation should be suspended or reassigned.

A transition into vehicle charging may occur when the supervisory arrangement determines that the AC reference is stable, that PV output or other energy sources are available, and that EV 42 is connected and ready to accept charge. The supervisory arrangement may also evaluate SOC thresholds or load demands when determining whether charging should begin. Charging may proceed concurrently with coordinated-output operation or directly from PV energy.

A transition into the grid-restoration state may occur when the supervisory arrangement detects the return of utility grid voltage and frequency. The supervisory arrangement may evaluate the persistence of grid conditions before instructing converters to deactivate. A controlled sequence may follow, including deactivation of reference generation, deactivation of coordinated-output participation, and activity on relays that support reconnection to the utility source. The system may then transition back to standby during grid-connected operation.

Fault-based transitions may occur at any time. If a converter reports a hardware fault or if AC bus measurements fall outside expected ranges, the supervisory arrangement may deactivate active converters and return to the standby state while maintaining monitoring functions. These transitions support system protection and provide a consistent fallback condition during unexpected events.

After the supervisory volt-frequency arrangement establishes a stable AC reference on the AC bus, grid-following devices such as PV inverter 52 may resume operation. Reintegration generally occurs once the supervisory arrangement verifies that bus conditions fall within voltage and frequency ranges suitable for downstream synchronization.

The supervisory arrangement may confirm several conditions before reintegration begins. These conditions may include the presence of an AC voltage across L1 and L2, a frequency within a predetermined operating range, and indications that no converter-level faults are present. Reintegration may also depend on PV availability, which may be inferred from PV inverter 52 status messages or other system-level indicators. Reintegration may be deferred if the AC reference has not stabilized or if internal checks indicate that additional converter preparation is needed.

Once the AC reference is detected, PV inverter 52 may rely on its internal grid-following logic to synchronize with the waveform. Internal checks performed by PV inverter 52 may include voltage validation, frequency validation, or other criteria used by the inverter to establish synchronization. After these checks, PV inverter 52 may begin contributing AC power to bus 18. This transition occurs autonomously within the inverter's own control framework once eligibility is established.

During reintegration, the supervisory arrangement manages state transitions rather than the internal synchronization behavior of PV inverter 52. The supervisory arrangement may confirm that reference conditions remain within specified ranges, adjust converter roles based on real-time conditions, or authorize entry into subsequent states such as coordinated-output operation or charging. The supervisory arrangement may also respond to variations in PV output by modifying converter participation if needed.

Reintegration may occur whether only one converter is active or if multiple converters are participating in a coordinated-output configuration. When more than one converter is active, the reference-producing converter maintains the AC reference while coordinated converter(s) operate in a compatible manner. PV inverter 52 may synchronize to the reference regardless of whether coordinated-output behavior is active.

Other grid-following devices may also reconnect once the reference is present. These devices may include microinverters, storage systems operating in grid-following mode, or residential loads that require a voltage and frequency reference. Reintegration of these devices may follow the same sequence applied to PV inverter 52, with each device resuming operation under its own control logic.

After PV inverter 52 begins producing power, the supervisory arrangement may evaluate whether conditions support vehicle charging. These evaluations may include PV output levels, residential load levels, and SOC thresholds for traction battery 70. If these conditions are met, the supervisory arrangement may authorize a transition into the charging state described previously. Reintegration therefore supports energy harvesting and downstream charging through a structured supervisory transition.

Following reintegration, the supervisory arrangement may adjust converter participation as conditions evolve. The arrangement may maintain reference generation, enable continued coordinated-output operation, or transition toward charging. Reintegration may occur multiple times if bus conditions are disrupted and subsequently restored, and the supervisory arrangement may return to earlier states if voltage or frequency deviates from acceptable ranges.

After the supervisory volt-frequency arrangement establishes a stable AC reference and downstream components have reconnected, the system may enter a state in which traction battery 70 of EV 42 can be charged. Charging may occur when the supervisory arrangement determines that energy is available from PV inverter 52 or another source, that EV 42 is connected through EVSE 40, and that conditions support charging.

The supervisory arrangement may evaluate several inputs before enabling charging. These inputs may include PV output, residential load levels within home 12, SOC of traction battery 70, and indications of converter readiness. Additional factors may include SOC of converter battery 62, communication signals from EVSE controller 98 and vehicle controller 82, and confirmation that the AC reference remains within supervisory voltage and frequency ranges. The supervisory arrangement may rely on these signals to determine whether charging should begin, be delayed, or remain disabled.

Charging may be enabled when system conditions indicate that energy is available for delivery to the traction battery. This may include periods in which PV output exceeds residential load or when the supervisory arrangement determines that sufficient capacity is available to support charging without compromising other system functions. The supervisory arrangement may also confirm that traction battery 70 SOC is within acceptable bounds for receiving energy and that AC bus voltage and frequency remain stable.

Once charging is authorized, the supervisory arrangement may confirm readiness of EVSE 40 and may enable EV AC charger 78 or EVSE power converter 96 to begin drawing power. The supervisory arrangement does not alter charger-side current control or voltage control; instead, it provides the enabling conditions that permit these components to begin their internal charging sequences. The converter assigned to generate the AC reference may remain active throughout this interval, and coordinated-output converters may participate if conditions support their involvement.

Charging may occur whether only the reference converter is active or whether additional converters are contributing power through coordinated-output operation. The supervisory arrangement may maintain or adjust converter participation based on real-time power flow requirements, PV availability, or internal readiness indicators. If coordinated-output participation is active, the coordinated converter may remain enabled or may be deactivated depending on system conditions.

PV-generated energy may be used to charge traction battery 70 once PV inverter 52 has reintegrated with the AC bus. During a grid outage, the generated AC reference allows PV inverter 52 to resume operation, and the supervisory arrangement may evaluate PV output to determine whether charging is appropriate. Charging may continue as long as PV output remains sufficient and the AC reference remains stable.

Charging may be suspended when system conditions change. Suspension may occur when traction battery 70 reaches a supervisory SOC threshold, when PV output decreases, when voltage or frequency moves outside acceptable ranges, or when system 10 transitions toward grid restoration. Suspension may also occur if coordinated-output participation becomes unavailable or if fault indicators are reported by downstream components. Under these conditions, EVSE 40 may return to a passive or monitoring state until conditions change.

Charging may resume after a suspension when PV output increases, SOC conditions shift, or supervisory voltage and frequency conditions return to acceptable ranges. Resumption may occur automatically under supervisory control once the required inputs indicate that charging can proceed.

Charging may also interact with other supervisory transitions. If converter roles change or if coordination between converters shifts, charging may continue without interruption provided that reference integrity remains present. If reference conditions are disrupted, charging may pause until the supervisory arrangement reestablishes the AC reference.

FIG. 8 depicts the charging state as a distinct supervisory condition that may be reached after reintegration and, in some cases, coordinated-output participation. Charging may occur while the system remains in islanded mode or until grid-restoration transitions begin. The supervisory arrangement remains responsible for determining when charging is enabled, suspended, resumed, or concluded, while charger-side hardware manages the controlled delivery of energy to traction battery 70.

In some embodiments, the supervisory arrangement may include adaptive logic that adjusts one or more supervisory parameters based on data gathered during prior system operation. The adaptive logic may generate updated operating ranges or decision thresholds for use when assigning converter roles, authorizing charging, or evaluating conditions for reference generation. These adjustments may be produced by analytical techniques, learned models, or other data-driven processes configured to evaluate historical operating patterns.

The adaptive logic may receive inputs associated with prior converter participation, measured voltages, measured frequencies, transitions between supervisory states, PV output history, traction-battery state-of-charge patterns, or timing associated with vehicle connections. Additional contextual inputs may include environmental or usage conditions such as recent household load levels, PV availability patterns, or other non-limiting operational factors that influence expected system behavior. Using these inputs, the adaptive logic may produce updated supervisory parameters such as revised voltage ranges, frequency ranges, state-transition sensitivity values, or eligibility thresholds for coordinated-output participation or charging.

The adaptive logic may operate locally within system 10, EVSE 40, or EV 42, or may be distributed among these components. In some embodiments, the adaptive logic may run periodically or upon specific events such as completion of an islanded session, detection of repeated state transitions, or accumulation of sufficient historical data. Outcomes generated by the adaptive logic may serve as optional guidance for supervisory decisions and need not override real-time measurements or protective conditions. The supervisory arrangement may also accept or reject adaptive parameter changes based on converter readiness, fault status, or other operating constraints.

In certain implementations, the adaptive logic may update parameters used to identify which converter is expected to serve as the reference source during islanded operation. Updated parameters may reflect observed trends in converter availability, battery conditions, or PV contribution. Similarly, parameters associated with voltage-range selection, frequency-range selection, or timing of reintegration may be adjusted based on prior behavior. These updates may support supervisory decisions during subsequent operating intervals without requiring any specific control technique for voltage or frequency control within the converters themselves.

The adaptive logic may also evaluate conditions that arise during coordinated-output or charging states. For example, if repeated transitions into charging suspension occur due to insufficient PV output, the adaptive logic may update supervisory thresholds related to charging eligibility. Likewise, if coordinated-output participation was frequently interrupted due to converter availability, the adaptive logic may update supervisory parameters associated with converter role assignment. These adjustments may be applied only when conditions permit and remain subordinate to protective thresholds.

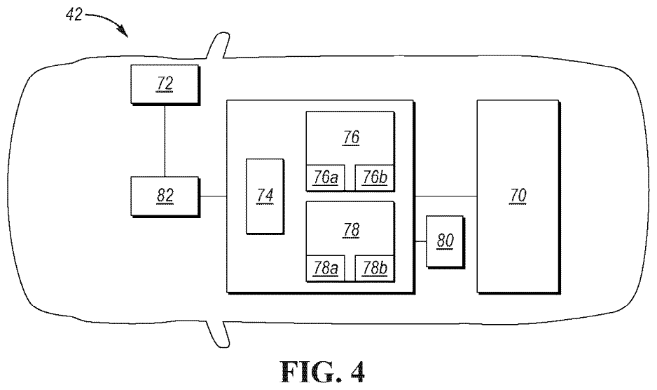

Referring to FIG. 4, the electric vehicle 42 includes a traction battery 70, a vehicle charging interface 72, a battery charge control module 74, and a power converter 76. The traction battery 70 stores DC energy for propulsion and onboard systems and may also serve as the energy source for the power converter 76 when the vehicle participates in backup power operation.

The vehicle charging interface 72 provides the electrical and signaling connection between the electric vehicle 42 and the EVSE 40. In the illustrated embodiment, the interface 72 supports bidirectional transfer of power so that the vehicle may receive AC power from the EVSE 40 for charging or deliver AC output toward the EVSE 40 when local power is required. The interface 72 includes signaling paths for exchanging charging information, vehicle status, and indications related to the presence or absence of an external AC reference. In some embodiments, the interface 72 also supports synchronization signals that assist the power converter 76 in coordinating with external devices such as the PV inverter 52. The interface 72 may also serve as the activation point for the power converter 76 when the electric vehicle 42 is connected to the EVSE 40 and the system transitions to islanded operation. The interface 72 may be implemented using a CCS port, a J1772 connector, or another standardized or proprietary design.

The traction battery 70 is connected to the battery charge control module 74, which manages battery charge state, monitors temperature, and controls energy transfer with the traction battery 70. The battery charge control module 74 includes or is connected to the power converter 76. In addition to its battery management functions, the battery charge control module 74 may determine when islanded operation is required. The battery charge control module 74 may monitor for the presence of a voltage and frequency reference at the vehicle charging interface 72 and activate the power converter 76 when utility power is unavailable and operating conditions such as state of charge, battery temperature, or user authorization are satisfied. The battery charge control module 74 may also control energy flow through the power converter 76 so that energy may be delivered toward the AC bus 18 or received from the PV system 50 and used to charge the traction battery 70. In some embodiments, the battery charge control module 74 communicates with the vehicle controller 82 to report converter status, participate in load coordination, and help manage transitions into and out of islanded operation.

The power converter 76 may activate during a grid outage or when the electric vehicle 42 is placed in a charging or backup mode. The power converter 76 converts DC from the traction battery 70 into AC and can energize an external AC bus such as the bus 18 of FIG. 1. The AC output of the power converter 76 serves as the reference amplitude and frequency for grid-following devices such as the PV inverter 52.

The electric vehicle 42 includes one or more contactors that isolate or couple the traction battery 70 to the vehicle charging interface 72. These contactors allow selective connection of the traction battery 70 to the external circuitry and may also determine when the power converter 76 is electrically connected. The contactors are controlled by the vehicle controller 82 or the battery charge control module 74. When charging is permitted, the contactors close to support transfer of energy to or from the traction battery 70. When the power converter 76 is active, the contactors may couple the converter output to the interface 72.

The electric vehicle 42 also includes a low-voltage battery 80 that supplies DC power to control modules, contactors, sensors, and communication interfaces. The low-voltage battery 80 may remain available independently of the traction battery 70 and may support activation of the battery charge control module 74, the vehicle controller 82, or startup logic for the power converter 76 during an outage or when the vehicle is otherwise inactive. In some embodiments, the low-voltage battery 80 supports pre-charge sequences or communication signaling on the vehicle charging interface 72 to prepare for islanded operation.

The vehicle controller 82 coordinates energy-related functions between the electric vehicle 42 and external systems. The controller 82 may communicate with the EVSE 40 to negotiate charging parameters, share state-of-charge information, or exchange converter-related control signals. Communications may use signaling such as control pilot and proximity pilot paths or digital communication methods such as power line communication, CAN, or wireless channels. The vehicle controller 82 may also interface with the battery charge control module 74 to evaluate operating conditions and determine whether the power converter 76 should be active. These conditions may include state of charge, traction battery availability, requests from the EVSE 40 or the main controller 30, or the status of the PV system 50. In some implementations, the vehicle controller 82 participates in timing and sequencing during transitions between grid-connected and islanded modes and may report converter readiness or status to external components.

In the illustrated embodiment, the electric vehicle 42 includes an AC charger 78 configured to receive AC power from the EVSE 40 and convert it into DC for charging the traction battery 70. The AC charger 78 operates under control of the battery charge control module 74, which evaluates battery conditions such as voltage, temperature, and state of charge to determine charging behavior. The AC charger 78 includes power electronics that manage voltage control, current limiting, and charge sequencing. During operation, the AC charger 78 may receive commands from external controllers such as the EVSE 40 or the main controller 30 and may provide diagnostic or status information in return. The AC charger 78 may also support protection functions such as overvoltage or overcurrent monitoring.

The AC charger 78 includes a DC/DC converter 78a and a DC/AC inverter 78b. The DC/AC inverter 78b functions as an AC-to-DC rectifier during charging, converting AC into an intermediate DC link voltage. The DC link is then supplied to the DC/DC converter 78a, which adjusts voltage and current to match the charging requirements of the traction battery 70. The AC charger 78 may be constructed as a unified module or as a pair of coordinated stages. In some embodiments, the AC charger 78 supports reverse power flow so that energy from the traction battery 70 can be exported toward the AC bus 18 during V2G, V2H, or V2L operation.

The DC/AC inverter 78b produces the rectified DC link and may use modulation or filtering components to form the DC bus that feeds the DC/DC converter 78a. In reverse operation, the inverter 78b may generate an AC waveform on the vehicle charging interface 72 that is synchronized with the external reference present on the AC bus 18. In this operating mode, the inverter 78b may adjust amplitude, current, or phase to match external conditions.

The DC/DC converter 78a receives the DC link voltage and performs step-up, step-down, or bidirectional conversion to match the charging or discharging profile of the traction battery 70. The converter 78a may adjust its output in response to battery conditions and control commands from the battery charge control module 74 or vehicle controller 82. During discharging, the converter 78a manages the flow of energy from the traction battery 70 and provides controlled DC power to the inverter 78b.

In embodiments where the electric vehicle 42 includes a dedicated power converter 76, the power converter 76 may include a DC/DC converter 76a and a DC/AC power converter 76b. The power converter 76 converts DC from the traction battery 70 into an AC output suitable for energizing the AC bus 18 when utility power is unavailable. The resulting waveform provides the amplitude and frequency reference used by downstream devices such as the PV inverter 52.

The DC/DC converter 76a conditions the traction battery output and supplies a controlled DC link to the DC/AC power converter 76b. This conditioning may include voltage conversion, current limiting, and soft-start behavior. The DC/DC converter 76a may also isolate the traction battery 70 from high-frequency switching activity.

The DC/AC power converter 76b produces the AC waveform on the vehicle-side terminals of the vehicle charging interface 72. The power converter 76b may operate independently or in coordination with other converters within the system 10, such as the power converter 60 of the home energy system. The waveform produced by the power converter 76b serves as the reference signal for the islanded portion of the system 10 when utility power is unavailable. The converter 76b may be selectively activated based on commands from the battery charge control module 74 or the vehicle controller 82 and may return to an inactive or monitoring state when grid power is restored or when the state of charge of the traction battery 70 falls below a defined threshold.

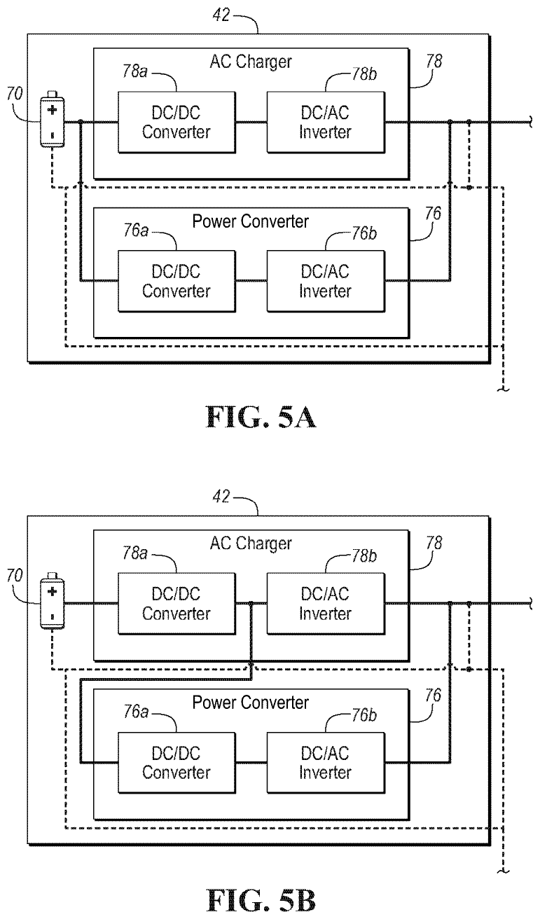

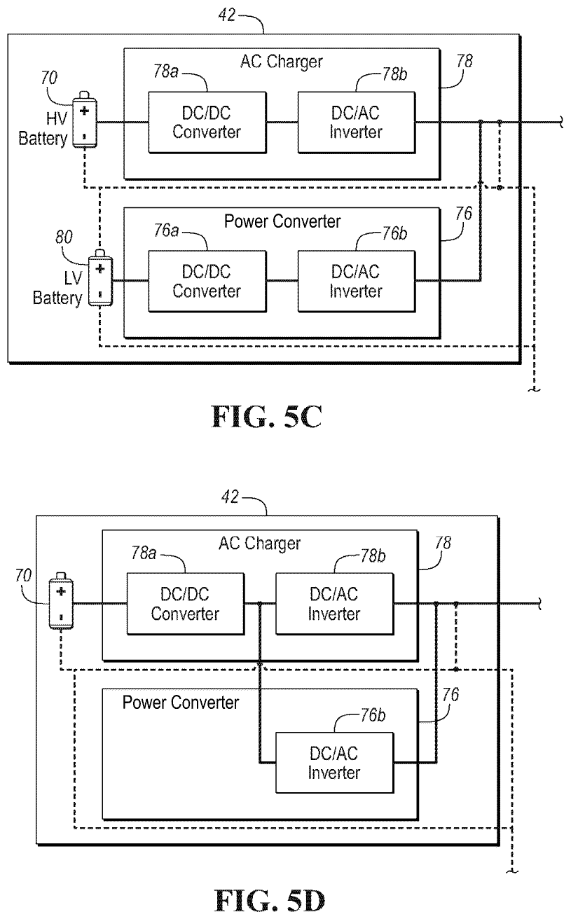

Referring to FIG. 5A, an embodiment of the electric vehicle 42 is shown in which both the AC charger 78 and the power converter 76 receive DC power from the traction battery 70. In this arrangement, the DC/DC converters 78a and 76a each draw power directly from the traction battery 70 and condition the battery output for their respective stages. The DC/DC converters 78a and 76a may include hardware features suitable for managing high-voltage input, such as current-limiting components, reverse-polarity detection circuits, soft-start circuits, overvoltage limiting elements, and pre-charge circuitry for controlling inrush current. The converters may also incorporate isolated gate drivers, isolated feedback channels, and thermal protection features. By using independent power paths, the AC charger 78 and the power converter 76 can operate as separate subsystems, each maintaining its own power conditioning and control functions.

Referring to FIG. 5B, another embodiment is shown in which the power converter 76 receives its power input from the traction battery 70 through the AC charger 78. In this configuration, the DC/DC converter 78a of the AC charger 78 is connected directly to the traction battery 70 and performs the primary interface and protection functions required for high-voltage operation. The output of the DC/DC converter 78a provides a conditioned DC supply that feeds both the charger inverter 78b and the DC/DC converter 76a of the power converter 76. In this arrangement, converter 76a remains part of the power converter 76 but does not handle raw battery voltage, allowing it to be implemented using a lower-complexity design that provides local conditioning or voltage matching for the downstream stage 76b. This architecture may reduce duplication of input-side components while maintaining independent operation of charging and AC-output functions.

Referring to FIG. 5C, another embodiment is shown in which the power converter 76 draws its power input from a low-voltage auxiliary battery 80, while the AC charger 78 remains connected to the traction battery 70. In this arrangement, the DC/DC converter 78a continues to supply conditioned DC power to the AC charger inverter 78b, and the traction battery 70 remains the primary source of energy for charging. The power converter 76, however, uses the auxiliary battery 80 as its input source. The auxiliary battery 80 may provide a nominal voltage such as 12V or 48V and may be electrically isolated from the traction battery 70. This separation allows the power converter 76 to operate independently from the high-voltage bus and may be advantageous in applications where isolation between propulsion and auxiliary subsystems is desired. The auxiliary battery 80 may also support rapid activation of the power converter 76 when the traction battery 70 is deeply discharged or otherwise unavailable for high-voltage operation.

Referring to FIG. 5D, another embodiment is shown in which the DC/DC converter 76a of the power converter 76 is omitted. In this configuration, the DC/DC converter 78a of the AC charger 78 is adapted to supply conditioned DC power to both the charger inverter 78b and the power converter 76b. The output of the converter 78a therefore forms a shared DC link that serves both charging and AC-output functions. The traction battery 70 is electrically connected to the converter 78a, and the inverter stages 78b and 76b draw power from the common DC node. This architecture may reduce component count, simplify internal distribution of DC power, and reduce interconnection complexity. In some embodiments, the DC/DC converter 78a may supply multiple output branches or incorporate switching elements that control priority among charging, AC-output operation, or other functions associated with coordination of vehicle energy systems.

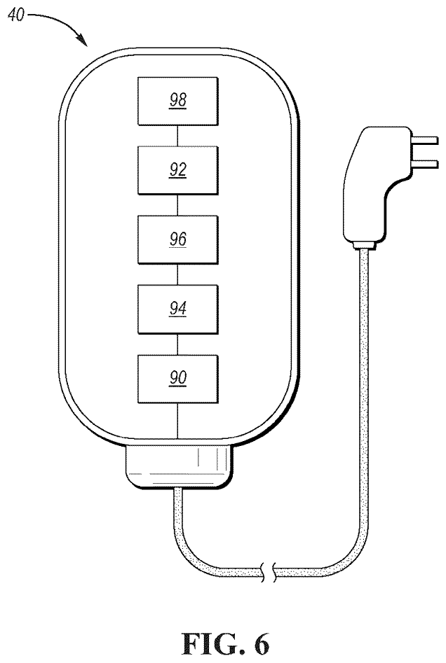

Referring to FIG. 6, the EVSE 40 includes a vehicle interface 90, a power inverter 92, a relay contactor 94, a power converter 96, and an EVSE controller 98. The vehicle interface 90 connects to the vehicle charging interface 72 when the electric vehicle 42 is plugged in and may include an insertable plug portion with signaling or detection circuitry located within the plug or within the EVSE housing. The vehicle interface 90 supports bidirectional transfer of power and signaling associated with charge negotiation and coordination with the power converter 76 or the power inverter 92 during islanded operation. In some embodiments, the vehicle interface 90 includes proximity sensing, plug-in detection, and compatibility indicators used by the EVSE controller 98 to determine whether charging or AC-output functions should proceed. The vehicle interface 90 may also serve as a gating condition for activating the power inverter 92 so that AC-output operation occurs only when a valid vehicle connection and communication state are established.

The power inverter 92 within the EVSE 40 is configured to activate during a grid outage and generate an AC waveform on the AC bus 18. The inverter 92 may receive power from an auxiliary EVSE battery or from energy present on the AC bus 18 when islanded generation such as PV power is available. The power inverter 92 may operate independently or in coordination with the power converter 76 of the electric vehicle 42. In some embodiments, only one of these devices is active at a given time, while in others the devices cooperate to provide an AC reference depending on system conditions and supervisory control logic elsewhere in the system 10.

The relay contactor 94 is located within the EVSE 40 to selectively connect or isolate the power path between the AC bus 18 and the power converter 96. The relay contactor 94 may be managed by the EVSE controller 98 based on voltage and frequency conditions, vehicle connection state, or coordination signals received from the main controller 30 or the vehicle controller 82. During a grid outage, the relay contactor 94 may remain open until the EVSE controller 98 determines that a suitable AC reference is active on the AC bus 18. The relay contactor 94 may close to enable charging of the electric vehicle 42 from PV-generated energy or open when converter-generated voltage falls outside of acceptable ranges or when a fault is detected. In this way, the relay contactor 94 supports transitions between charging and AC-output operation during both grid-connected and islanded conditions.

The power converter 96 receives AC power from the AC bus 18 and converts it into DC power suitable for charging the traction battery 70. The power converter 96 may include a rectifier stage, a DC/DC conversion stage, and associated control electronics for managing voltage and current during charging. In grid-connected mode, the power converter 96 may operate from the AC line voltage supplied by the grid 22. During islanded operation, the power converter 96 may instead receive its AC input from converter-generated waveforms, such as the output of the power converter 76 or the power inverter 92. The power converter 96 may incorporate internal sensing or operate under supervision of the EVSE controller 98 to determine if AC parameters are suitable for charging. In some embodiments, the power converter 96 includes filtering elements, isolation devices, or protection circuitry to support bidirectional energy flow or to satisfy certain requirements. The ability of the power converter 96 to charge from converter-generated AC allows the EVSE 40 to support photovoltaic-based charging of the electric vehicle 42 during grid outages.

The EVSE controller 98 manages communication with the vehicle controller 82, including exchange of state-of-charge information, current limits, and charging enablement signals. The EVSE controller 98 may support analog signaling such as control pilot and proximity pilot channels as well as digital communication methods including power line communication, CAN messages, or wireless links. The EVSE controller 98 may monitor state-of-charge information and determine when to initiate or suspend charging. It may also receive charging constraints or limits from the electric vehicle 42 and configure the power converter 96 accordingly. In embodiments that include the power inverter 92, the EVSE controller 98 may coordinate activation of the inverter based on vehicle connection status, availability of PV power, or signals from the main controller 30. The EVSE controller 98 may determine when the inverter 92 should activate during an outage and when charging is appropriate based on available energy on the AC bus 18. The EVSE controller 98 may also initiate deactivation of inverter behavior and return to grid-connected operation when utility power is restored.

The EVSE controller 98 may also exchange commands or status signals with the main controller 30 of the AC coupled system 10. This facilitates coordinated charging behavior based on the availability of PV energy or system-level thresholds. The EVSE controller 98 may delay charging until a suitable amount of PV power is available or until the state of charge of the traction battery 70 falls below a defined level. The EVSE 40 may include sensors to measure voltage and frequency on the AC bus 18 and may selectively activate the power inverter 92 based on those measurements. The EVSE controller 98 may further deactivate inverter operation upon detection of grid power return and support the system 10 during transitions between islanded and grid-connected modes.

In various embodiments, the components of the EVSE 40, including the vehicle interface 90, power inverter 92, relay contactor 94, power converter 96, and EVSE controller 98, may be housed within a common enclosure 100 to form a consolidated assembly. The enclosure 100 may include mounting structures, thermal management elements, and isolation barriers arranged to accommodate high-voltage and low-voltage circuitry. In some implementations, all components 90 through 98 are located within a single housing mounted to a wall, pedestal, or integrated charging station structure. In other implementations, one or more components are located in a separate enclosure due to thermal partitioning, spatial limitations, retrofit constraints, or electromagnetic isolation requirements. The housings may be interconnected with signal and power harnesses and may operate cooperatively under control of the EVSE controller 98 or another supervisory unit.

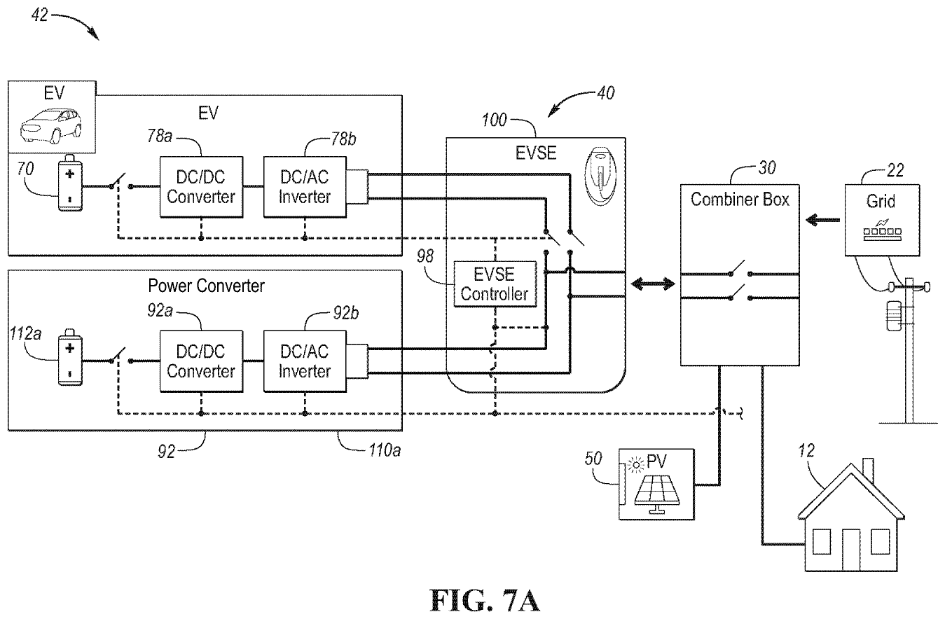

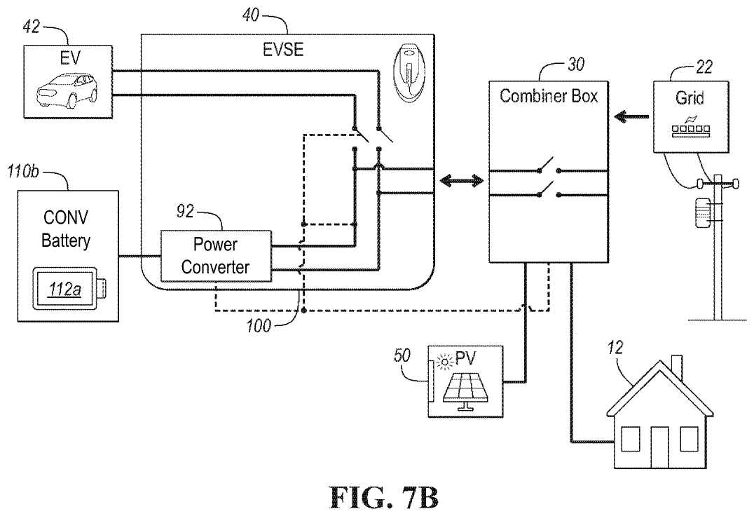

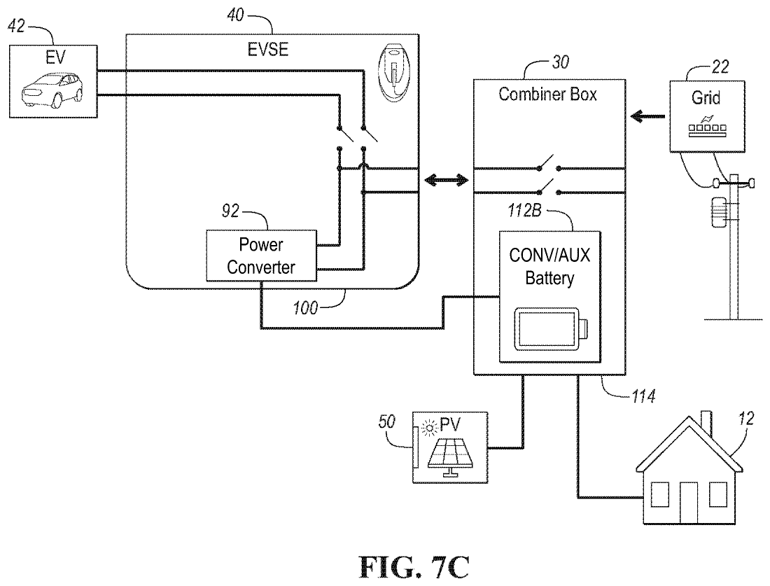

For example, referring to FIG. 7A, the EVSE controller 98 and selected components such as the vehicle interface 90, relay contactor 94, and power converter 96 are located within the EVSE housing 100. The power inverter 92, however, is positioned in a separate enclosure 110a located externally from the EVSE housing 100. The enclosure 110a may include structural features and thermal accommodations suited to the power inverter 92. This arrangement may be useful when the power inverter 92 generates substantial heat, benefits from additional clearance, or is better positioned apart from the control and communication circuitry associated with the EVSE controller 98. The power inverter 92 may be electrically and communicatively connected to components within the housing 100 using high-current conductors and signal cabling, allowing coordinated behavior under the control of the EVSE controller 98 while permitting physical separation of hardware.

As shown in FIG. 7A, the power inverter 92 includes a DC/DC converter 92a and a DC/AC power inverter 92b. The DC/DC converter 92a draws DC power from an inverter battery 112a located within the same enclosure 110a. The converter 92a may include circuitry to manage voltage levels, current flow, and pre-charge behavior for the subsequent stage 92b. The DC/AC power inverter 92b produces an AC waveform suitable for energizing the AC bus 18 during a grid outage. The AC output generated by the inverter 92b may serve as the reference for downstream devices such as the PV inverter 52. Coordination of inverter 92b with the EVSE controller 98 or the main controller 30 may govern its activation based on grid status, PV availability, or charging requirements. Co-locating the inverter battery 112a and the power inverter 92 within the enclosure 110a may reduce high-current cable lengths and support modular positioning of the inverter subsystem independent of the EVSE housing 100.

Referring to FIG. 7B, another embodiment is shown in which the power inverter 92 is located within the EVSE housing 100 while the inverter battery 112a is located in a separate enclosure 110b. The power inverter 92 receives high-voltage DC input from the battery 112a through shielded conductors and may include circuitry for voltage detection, inrush control, and fault isolation. Physical separation of the battery 112a from the power inverter 92 may allow the battery to be located in a different enclosure or position. This separation may support battery upgrades or replacement without accessing the EVSE internal hardware. The configuration may also accommodate compact EVSE enclosures by relocating the thermal and spatial demands associated with the battery.

Referring to FIG. 7C, another embodiment is shown in which the power inverter 92 is located within the EVSE housing 100 and is powered by a combined inverter battery and auxiliary battery 112b. The combined battery 112b is housed within or near a controller enclosure 114 that also interfaces with the PV system 50 and the home 12. The battery 112b includes internal voltage pathways or circuits capable of supplying high-voltage power to the inverter 92 and low-voltage power for auxiliary functions. The auxiliary power functions may include energizing relays, enabling startup sequences of associated converters, and maintaining logic circuitry during transitions to islanded operation. A power line connects the battery 112b in the controller enclosure 114 to the EVSE housing 100 where the inverter 92 resides. This configuration may allow a single battery unit to support multiple distributed subsystems within the home energy system.

In one example implementation, during an islanded condition in which an AC bus is electrically isolated from an external grid, a power converter coupled to the AC bus may generate an AC waveform that establishes a reference voltage for supplying power to one or more loads. In a representative embodiment, the power converter is integrated within an electric vehicle and draws DC power from a traction battery to synthesize a sinusoidal waveform on a residential power line connected through electric-vehicle supply equipment. Upon detecting loss of grid voltage, such as when a storm interrupts utility service and the home becomes electrically isolated, the controller of the vehicle determines that no external voltage source is present and transitions the inverter into a grid-forming mode. In this mode, the inverter initially outputs a clean sinusoidal AC waveform defining a reference amplitude and a reference frequency, such as 240 volts RMS at 60.00 Hz, thereby energizing the home's AC bus with a stable starting point for subsequent control actions.

Once this reference waveform is established, the controller continuously monitors bus conditions, including instantaneous voltage, instantaneous frequency, rate of change of voltage (dV/dt), and rate of change of frequency (RoCoF). These measurements allow the controller to detect load-related conditions that naturally arise during operation of common household devices. For example, when a refrigerator compressor, furnace blower, or sump pump motor starts, the AC bus may experience a sudden voltage dip from approximately 240 V to 228-232 V, a momentary frequency deviation of 0.05-0.15 Hz, or a rapid change in real or reactive power flow. In some cases, the controller may classify the disturbance as primarily voltage-related based on voltage deviation exceeding a threshold such as 3-5% of nominal, or based on dV/dt exceeding a limit such as 10 V per cycle. In other cases, the disturbance may be classified as primarily frequency-related based on frequency deviation exceeding a threshold such as ±0.2 Hz, RoCoF exceeding a threshold such as 0.5 Hz per second, or a step change in real-power demand exceeding a predetermined level, such as an increase of more than 1 kW within a few cycles.

When the disturbance is classified as predominantly voltage-related, the controller initially adjusts only the amplitude of the inverter's output waveform while maintaining the reference frequency within a stability range, for example within ±0.1 Hz of 60.00 Hz. Amplitude adjustment may be implemented by increasing reactive power delivered by the inverter, such as supplying up to 800 var of reactive support, modifying a voltage droop-control slope, or applying a medium-speed voltage correction that unfolds over an interval of approximately 2-30 seconds depending on the severity of the disturbance. Similarly, when the disturbance appears primarily frequency-related, the controller may adjust only the frequency of the inverter output while maintaining the reference amplitude within a voltage-stability range, such as 231-249 V RMS. Frequency adjustment may include modifying real power delivered by the inverter, such as increasing real-power output toward a limit of approximately 3.6 kW, modifying a frequency droop-control slope (for example, −0.3 Hz per kW), or applying a fast-acting correction designed to stabilize the frequency within less than one second after the disturbance.

The controller evaluates whether such single-parameter adjustment is sufficient by continuing to observe the AC bus while the amplitude-only or frequency-only adjustment is underway. In some situations, voltage-only correction may be insufficient because the inverter reaches a reactive-power saturation point, such as Q-max, or because the voltage remains outside the stability range after a defined time period. Likewise, frequency-only correction may not suffice when increased real-power demand forces the inverter to approach a current limit or when the frequency remains below the stability band despite modulation of real-power output. In other scenarios, correcting one parameter may unintentionally worsen the other due to characteristics of residential wiring impedance or nonlinear load behavior. For example, increasing reactive power to correct voltage may raise inverter current draw and cause an additional frequency dip, or attempting to restore frequency may worsen voltage deviation under certain load combinations. Any of these conditions may constitute the load-related condition indicating that adjustment of only amplitude or only frequency is insufficient.

In response to determining that single-parameter correction is insufficient, the controller adjusts both the amplitude and the frequency of the AC waveform concurrently. During this combined control interval, the inverter may simultaneously modify both voltage-droop and frequency-droop slopes and may deliver coordinated real and reactive power support. For example, the inverter may increase real-power output by 1-2 kW while also supplying several hundred vars of reactive power, adjusting amplitude and frequency together to bring the AC bus back within acceptable stability limits. Combined control may be applied using a soft-transient ramp that limits the rate of change of power to prevent abrupt transitions, such as capping the rate of change of real power at 500 W per second. Through these concurrent adjustments, both the amplitude and the frequency of the output waveform may temporarily deviate from their nominal reference values but do so in a controlled manner that preserves overall system stability. In example operation, the voltage may be nudged upward from 232 V toward 240 V while the frequency is simultaneously raised from 59.85 Hz back toward 60.00 Hz, with both values settling into their respective stability bands over a smoothing interval.

As the load disturbance subsides and the inverter's combined corrections take effect, the controller detects a return to stable operation, which may include observing that bus voltage has settled within the defined voltage-stability range, that frequency has stabilized within ±0.1 Hz of the reference frequency, that dV/dt and RoCoF have returned to nominal background levels, and that real and reactive power flows have stopped changing rapidly. At this point, the controller may transition away from simultaneous amplitude-and-frequency adjustment and return the inverter to a steady-state mode that maintains the reference waveform. In this manner, the energy management system provides a flexible and adaptive approach to managing islanded AC power by initially applying amplitude-only or frequency-only control, monitoring for indications that such control is insufficient, and subsequently applying coordinated amplitude-and-frequency control to support the load and maintain the stability of the AC bus.

This approach is particularly useful in electric-vehicle-based implementations in which available real and reactive power may vary according to the state of charge of the traction battery and thermal management conditions. For example, if the state of charge falls below a threshold, such as 20%, the controller may reduce the permissible range of amplitude or frequency adjustment or limit the maximum real-power export to prevent over-discharging the battery. Likewise, inverter temperature or DC-link voltage constraints may influence whether the controller attempts amplitude-only adjustment, frequency-only adjustment, or immediate combined control. In some embodiments, the controller may record historical load signatures, such as repeated compressor startup patterns or HVAC cycling behavior, and may revise transition thresholds or even preemptively adjust amplitude or frequency based on the likelihood of a future disturbance. Through this combination of dynamic measurement, adaptive classification, and multi-axis control, the system provides a robust mechanism for delivering stable power to household loads during islanded operation using an electric vehicle as the primary energy source.

The embodiments described above illustrate configurations that include a single power converter within a given subsystem, such as the power converter 60 in the system 10, the inverter 92 or power converter 96 within the EVSE 40, or the power converter 76 within the electric vehicle 42. In some residential or commercial environments, more than one power converter may be present. For example, a residence may include a power converter 60 associated with the system 10, an EVSE 40 equipped with its own AC-output capability, and an electric vehicle 42 capable of producing an AC reference through its power converter 76. In such arrangements, coordination may be provided so that a single device generates the AC reference at a given time, or that multiple AC-output devices operate in a compatible manner.

In one embodiment, the main controller 30 functions as a supervisory controller for managing AC-output behavior among available devices in the system 10. Upon detecting a grid outage, the main controller 30 may evaluate the status and readiness of each power converter and select one to serve as the active AC-output source. The selection may be based on parameters such as converter availability, battery conditions, thermal status, or recent operating state. If the electric vehicle 42 is not connected or if its traction battery 70 is below a defined state-of-charge threshold, the main controller 30 may inhibit operation of the power converter 76 and instead activate the inverter 92 or the power converter 60. Coordination may occur through direct signaling or through local decision logic that responds to broadcast status information from the main controller 30.

In another embodiment, the power converters may operate using a mutual-exclusion approach. Each device monitors the AC bus 18 for an existing reference waveform before attempting to generate its own. If a valid waveform is detected, indicating that another device is active, the power converter remains in a passive or standby state. If no reference is detected within a defined period, the device may activate its AC-output stage. This approach supports autonomous operation without requiring centralized arbitration. In some cases, converters may implement timing offsets or staggered startup intervals to reduce the possibility of simultaneous activation.

In certain implementations, more than one power converter may operate concurrently in a synchronized configuration, including arrangements that use parallel inverter stages. In these systems, power converters may coordinate through communication links and maintain alignment through shared timing references or phase coordination methods. This configuration may support seamless transitions between grid-connected and islanded operation, allow dynamic adjustment of converter participation, or provide resiliency through redundancy. Each converter may report operating measurements to the main controller 30 or to a distributed control group to support coordinated system behavior.

In other embodiments, coordination logic may reside within the EVSE controller 98 or the vehicle controller 82. For example, if the EVSE 40 detects that the system 10 is isolated from the grid and no AC reference is present, the EVSE controller 98 may activate the inverter 92. If the EVSE controller 98 later receives information from the main controller 30 indicating that another converter is active, it may deactivate the inverter 92 and shift to a passive operating state. Similarly, the vehicle controller 82 may withhold activation of the power converter 76 when it detects a stable external reference at the vehicle charging interface 72. This decentralized approach allows each device to manage its own state based on locally sensed or received information without requiring constant communication with a central controller.

A residential energy system may support bidirectional power flow between the electric vehicle 42 and the PV system 50. Through components such as the EVSE 40, the power converter, and the AC bus 18, the electric vehicle 42 may help establish conditions that allow the PV system 50 to resume operation during a grid outage and may then receive energy from the PV array for charging. Charging behavior may be guided by control decisions informed by PV output, system demand, and the state of charge of the traction battery 70. Coordination between the main controller 30, the EVSE controller 98, and the vehicle controller 82 may determine when charging or AC-output operation is suitable.

State-of-charge information may be used to determine whether the electric vehicle 42 participates in AC-output operation or charging. In some implementations, if the state of charge drops below a lower threshold, activation of the power converter 76 may be inhibited or charging may be deferred. If the state of charge rises above an upper threshold and PV production is available, the system may allow charging. These thresholds may be preset, user-configurable, or adjusted dynamically based on solar availability or system conditions.

The control system may support a sequence for transitioning into islanded operation. A designated converter may activate first to establish the AC waveform, followed by closure of the NFT relay 16 to create a grounded neutral reference. Once a stable waveform is present, the PV inverter 52 may resume AC production. Charging of the electric vehicle 42 may occur when PV output, home demand, and traction battery state of charge satisfy defined conditions. In systems with more than one available converter, the main controller 30 may select which converter engages based on priority or real-time availability. Alternatively, distributed logic may allow converters to activate when no external reference is present.

When grid power is restored, the system may transition by suspending PV injection, reducing output of the active converter, opening the NFT relay 16, and reconnecting to the utility grid through the main breaker 20. During these transitions, the electric vehicle 42 may continue to participate in PV coordination, charging, or support functions based on control signals, state-of-charge levels, and energy availability.

The algorithms, supervisory processes, or control routines disclosed herein may be implemented by one or more computing devices, controllers, or processing units, including discrete electronic control modules or distributed processing systems. The control logic may be stored as instructions on non-transitory computer-readable media, including read-only memory, flash memory, or other semiconductor memory devices, and may be executed by processors associated with components such as the main controller 30, the EVSE controller 98, the battery charge control module 74, or other system controllers. The disclosed routines may also be encoded in programmable logic, implemented using software-executable objects, or realized through hardware components such as field-programmable gate arrays, application-specific integrated circuits, or state machines. Any combination of firmware, hardware, and software may be used to implement the supervisory coordination, state transitions, or power-processing behaviors described throughout this specification.

The embodiments described herein are presented for purposes of illustration and are not intended to represent an exhaustive listing of all configurations encompassed by the claims. The terms used in this description are intended as descriptive language rather than limiting terminology. Variations in structure, placement, or functional distribution may be made without departing from the scope of the disclosed subject matter. References to a “controller” may include a single controller or a set of communicating controllers that collectively perform the described functions, and responsibilities attributed to a particular controller may be distributed among multiple devices. Such variations are understood to fall within the general concepts disclosed herein.

As described, features from various embodiments may be combined to form additional configurations even when such combinations are not explicitly illustrated. Although certain embodiments may be described as preferred for specific operating conditions or as providing particular performance characteristics, those of ordinary skill in the art will recognize that implementation choices may involve tradeoffs among control behavior, energy availability, system packaging, or other operational considerations. Embodiments that differ in one or more characteristics from those emphasized in the description are nonetheless within the scope of the disclosure and may be suitable for particular installations or supervisory-control strategies.

What is claimed is:

1. An energy management system for delivering power to a load via a power line, comprising:
a power converter coupled to the power line and operable to generate, during a condition in which the power line lacks an external voltage source, output on the power line that defines a reference amplitude and a reference frequency; and
a controller programmed to direct the power converter to:
(i) adjust an amplitude of the output while maintaining the reference frequency;
(ii) adjust a frequency of the output while maintaining the reference amplitude; and
(iii) adjust the amplitude and the frequency of the output concurrently.

2. The energy management system of claim 1, wherein the power converter is housed within a home-energy-management enclosure that includes a low-voltage auxiliary power source supplying control power to the controller during the condition.

3. The energy management system of claim 1, further comprising electric-vehicle supply equipment coupled to the power line, wherein the controller receives information indicative of a connection state of an electric vehicle and adjusts operation of the power converter based at least in part on the connection state.

4. The energy management system of claim 1, wherein the power converter is located within an electric vehicle and draws DC power from a traction battery to generate the output.

5. The energy management system of claim 1, further comprising a grid-following device coupled to the power line, and wherein the controller directs at least one of amplitude adjustment or frequency adjustment based on an electrical contribution of the grid-following device.

6. A vehicle comprising:
a traction battery;
an inverter electrically connected with the traction battery; and
a controller programmed to (i) operate the inverter to establish, on a power line external to the vehicle, a reference voltage having a reference amplitude and a reference frequency, (ii) adjust an amplitude of generated voltage while maintaining the reference frequency within a frequency range or adjust a frequency of the generated voltage while maintaining the reference amplitude within an amplitude range, and (iii) in response to the amplitude or the frequency departing from the corresponding range during adjustment of only one of the amplitude or the frequency, adjust both the amplitude and the frequency of the generated voltage such that both differ from the reference amplitude and the reference frequency.

7. The vehicle of claim 6 wherein the controller is further programmed to limit adjustment of the amplitude or the frequency based on a state-of-charge of the traction battery falling below a value.

8. A method of operating a power converter coupled to an AC bus, the method comprising:
generating, by the power converter during an islanded condition, an AC output on the AC bus that defines a reference voltage including a reference amplitude and a reference frequency;
adjusting one of an amplitude of the AC output or a frequency of the AC output, while not adjusting the other; and
in response to a load-related condition on the AC bus indicating that adjusting only the amplitude or only the frequency is insufficient, adjusting both the amplitude and the frequency of the AC output to supply power to a load coupled to the AC bus.

9. The method of claim 8, wherein adjusting the amplitude occurs when at least one of:
(a) a deviation of bus voltage exceeds a voltage-deviation value,
(b) a rate of change of voltage on the AC bus exceeds a rate-of-change value, or
(c) reactive-power demand on the AC bus exceeds a reactive-power value.

10. The method of claim 8, wherein adjusting the frequency occurs when at least one of:
(a) a deviation of bus frequency exceeds a frequency-deviation value,
(b) a rate of change of frequency (RoCoF) exceeds a RoCoF value, or
(c) a step change in real-power load on the AC bus exceeds a real-power deviation value.

11. The method of claim 8, wherein adjusting the amplitude includes at least one of:
(a) modifying reactive power delivered by the power converter while maintaining the reference frequency,
(b) modifying a voltage droop-control slope, or
(c) applying a medium-speed voltage correction over an interval between approximately two seconds and approximately thirty seconds.

12. The method of claim 8, wherein adjusting the frequency includes at least one of:
(a) modifying real power delivered by the power converter while maintaining the reference amplitude,
(b) modifying a frequency droop-control slope, or
(c) stabilizing the frequency within less than one second after a load disturbance.

13. The method of claim 8, wherein adjusting both the amplitude and the frequency occurs in response to at least one of:
(a) saturation of a control parameter during amplitude-only adjustment,
(b) persistent voltage deviation after amplitude-only adjustment for a defined period,
(c) persistent frequency deviation after frequency-only adjustment for a defined period, or
(d) deviations in both bus amplitude and bus frequency exceeding respective thresholds.

14. The method of claim 8, further comprising adjusting the amplitude of the AC output and subsequently adjusting the frequency of the AC output before adjusting both simultaneously.

15. The method of claim 8, further comprising adjusting the frequency of the AC output and subsequently adjusting the amplitude of the AC output before adjusting both simultaneously.

16. The method of claim 8, further comprising sequentially adjusting the amplitude and the frequency of the AC output in any order prior to adjusting both simultaneously.

17. The method of claim 8, wherein adjusting both the amplitude and the frequency includes at least one of:
(a) concurrently adjusting active power and reactive power delivered by the power converter,
(b) modifying both a voltage droop-control slope and a frequency droop-control slope, or
(c) applying a soft-transient ramp that limits a rate of change of power.

18. The method of claim 8, further comprising recording load signatures on the AC bus and revising a transition threshold based on the recorded load signatures.

19. The method of claim 8, further comprising predicting a likelihood of a future voltage-related or frequency-related disturbance based on historical load signatures and preemptively adjusting the amplitude or the frequency of the AC output.

20. The method of claim 8, wherein the load-related condition includes at least one of:
(a) a deviation of bus voltage,
(b) a deviation of bus frequency,
(c) a rate of change of voltage,
(d) a rate of change of frequency,
(e) a change in real-power demand, or
(f) a change in reactive-power demand.
